(19) United States
(12) Patent Application Publication
(10) Pub. No.: US 2019/0137622 A1
(43) Pub. Date: May 9, 2019

(54) Method and System for Gauging External Object Movement and Conditions for Connected and Autonomous Vehicle Safety

(71) Applicants: Brennan Lopez-Hinojosa, Plano, TX (US); Kermit Lopez, Albuquerque, NM (US)

(72) Inventors: Brennan Lopez-Hinojosa, Plano, TX (US); Kermit Lopez, Albuquerque, NM (US)

(21) Appl. No.: 15/987,205

(22) Filed: May 23, 2018

Related U.S. Application Data
(63) Continuation of application No. 62/583,628, filed on Nov. 9, 2017.

(51) Int. Cl. G01S 13/93; B60W 30/09; B60W 30/095

(52) U.S. Cl. CPC G01S 13/931; B60W 30/09; G06T 7/70; B60W 2420/52; B60W 30/0956

(57) ABSTRACT

Methods and systems for gauging vehicle movement for use in facilitating automotive safety. In an example embodiment, a determination is made whether or not one or more objects (e.g., a car, a truck, a motorcycle, a bicycle, a pedestrian, etc) are in motion with respect to a vehicle in which a user/occupant of a vehicle is located, in response to identifying such objects with respect to the vehicle in which the user of the vehicle is located. The speed and trajectory of the identified object and the environmental condition surrounding the vehicle can be estimated, if it is determined that the identified object or objects are in motion. The speed and trajectory of the identified object can be then correlated with the environmental condition (e.g., whether it is raining, snowing, etc) and the type of identified object (e.g., a car or a particular make and model of the car, a pedestrian, etc) to generate data indicative of the speed and the trajectory of the identified object, which takes into account the environmental conditions (e.g., weather, rain, wind, temperature, pressure, etc) surrounding the vehicle and the type of identified object. An alert can be then generated that is indicative of safety factors such as as the speed and trajectory of the identified object or objects.

### CROSS-REFERENCE TO PROVISIONAL APPLICATION

This patent application claims priority under 35 U.S.C. 119(e) to U.S. Provisional Patent Application Ser. No. 62/583,628, entitled “Method and System for Gauging External Object Movement and Conditions for Connected and Autonomous Vehicle Safety,” which was filed on Nov. 9, 2017, the disclosure of which is incorporated herein by reference in its entirety.

### TECHNICAL FIELD

Embodiments are generally related to the field of connected vehicles including autonomous vehicles. Embodiments also relate to electronic mobile wireless devices that communicate with such vehicles. Embodiments also relate to connected vehicle technology and the deployment of electronic mobile wireless devices in the context of connected vehicles. Embodiments further relate to driver assist technologies. Embodiments further relate to systems, devices and methods that facilitate the prevent of automobile accidents.

### BACKGROUND

The availability of on-board electronics and in-vehicle information systems has accelerated the development of more intelligent vehicles. One possibility is to automatically monitor conditions surrounding a vehicle for safety purposes. Another possibility is to automatically monitor a driver's driving performance to prevent potential risks. Although protocols to measure a driver's workload have been developed by both government agencies and the automobile industry, they have been criticized as being too costly and difficult to obtain. In addition, existing uniform heuristics for driving risk preventions do not account for changes in individual driving environments. Hence, technologies for understanding a driver's frustrations to prevent potential driving risks has been listed by many international automobile companies as one of the key research areas for realizing intelligent transportation systems.

In addition to monitoring a driver's activity, there are also safety considerations such as the ongoing need to reduce the risk of automobile collisions, whether as a result of driver error or the fault of other driver's reckless driving behavior. There is also a need to monitor a vehicle occupant's activity with respect to certain conditions, which may be external to the vehicle or may occur within the vehicle. For example, a driver may be approaching a red light or the driver may be stopped at a red light and is looking at his cell phone or other distractions instead of being attentive to the traffic light. There is also a need to monitor various conditions external to the vehicle and/or internal to the vehicle and to provide alerts to vehicle passengers about these conditions or changes in such conditions.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for improved connected vehicle and driver assist methods and systems.

It is another aspect of the disclosed embodiments to provide for a method and system for alerting a driver and/or a passenger of a vehicle regarding a change in a condition external to the vehicle or within the vehicle.

It is still another aspect of the disclosed embodiments to provide methods and systems for gauging the movement of objects (e.g., other vehicles, cars, trucks, bicycles, motorcycles, pedestrians, etc) external to a vehicle and providing safely alerts to the vehicle occupant concerning such objects.

It is yet another aspect of the disclosed embodiments to provide automatic safety alerts to vehicle occupants regarding the speed and trajectory of other objects such as vehicles or pedestrians in correlation with current environmental conditions.

It is also an aspect of the disclosed embodiments to provide for the collection of data by one or more sensors mounted on a vehicle to generate data concerning other nearby objects such as vehicles or pedestrians and using such data to automatically move the vehicle into a position that avoids a trajectory of such other vehicles.

The aforementioned aspects and other objectives and advantages can now be achieved as described herein. Methods and systems are disclosed herein for gauging vehicle movement for use in facilitating automotive safety. In an example embodiment, a determination is made whether or not one or more objects are in motion with respect to a vehicle in which a user of the vehicle is located, in response to identifying such objects with respect to the vehicle in which the user of the vehicle is located. The speed and trajectory of the identified object or objects and the environmental condition surrounding the vehicle can be estimated, if it is determined that the identified object or objects are in motion. The speed and trajectory of the identified object can be then correlated with the environmental condition (e.g., whether it is raining, snowing, etc) and the type of identified object (e.g., such as the make and model and color of a car, or that the object is a pedestrian) to generate data indicative of the speed and the trajectory of the identified object, which takes into account the environmental condition and the type of identified object. An alert can be then generated for the user indicative of safety factors such as as the speed and trajectory of the identified object.

In some example embodiments, the aforementioned alert can be broadcast through a speaker associated with the vehicle in which the user is located and/or through a speaker of a client device associated with the user, wherein the client device is in communication with a PAN (Personal Area Network) associated with the vehicle and/or the client device is in communication with a cellular communications network and the alert is transmitted through the PAN and/or the cellular communications network for the broadcasting respectively through the speaker associated with the vehicle and/or the speaker of the client device. In some example embodiments, the data aforementioned data can be used to automatically move the vehicle toward a position or location that is estimated (based on such data) to avoid the trajectory of the object or objects and facilitate automotive safety of the vehicle with respect to the identified object or objects, thereby facilitating the possible avoidance of a collision between the identified object or objects and the vehicle in which the use is located.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates is an example of a vehicle with a plurality of sensors positioned on the exterior of the vehicle, in accordance with an example embodiment;

FIG. 2 illustrates an example of a systems layer of a connected or an autonomous vehicle, in accordance with an example embodiment;

FIG. 3 illustrates a schematic diagram of an alerting system for a vehicle, in accordance with an example embodiment;

FIG. 4(a) illustrates an example computing device constituting a smartphone or tablet computing device, which may be adapted for use in accordance with one embodiment;

FIG. 4(b) illustrates an example camera, which may be located in a vehicle for monitoring conditions external to the vehicle, in accordance with another embodiment;

FIG. 5 illustrates a method for alerting a vehicle occupant (e.g., a vehicle driver and/or passenger) via wireless communications, in accordance with an example embodiment;

FIG. 6 illustrates a method for alerting a vehicle occupant, in accordance with an alternative embodiment;

FIG. 7 illustrates a method for tracking a vehicle occupant's activity, in accordance with an alternative embodiment;

FIG. 8 illustrates a method for monitoring conditions with respect to a vehicle, in accordance with an alternative embodiment;

FIG. 9 illustrates a schematic diagram of a system for alerting a vehicle occupant via wireless communications, in accordance with an alternative embodiment;

FIG. 10 illustrates a schematic diagram of a system for alerting a vehicle occupant via wireless communications, in accordance with an alternative embodiment;

FIG. 11 illustrates a schematic diagram of a system for alerting a vehicle occupant via wireless communications, in accordance with an alternative embodiment;

FIG. 12 illustrates a method for alerting a vehicle occupant of a change in traffic light conditions via wireless communications, in accordance with an embodiment;

FIG. 13 illustrates a schematic view of a computer system, in accordance with an embodiment;

FIG. 14 illustrates a schematic view of a software system including a module(s), an operating system, and a user interface, in accordance with an embodiment;

FIG. 15 illustrates a schematic diagram an occupant alerting system, in accordance with an alternative embodiment;

FIG. 16 illustrates a flow chart of operations depicting logical operational steps of a method for gauging vehicle and/or object movement for use in facilitating automotive safety, in accordance with an example embodiment; and

FIG. 17 illustrates a flow chart of operations depicting logical operational steps of a method for gauging vehicle and/or object movement for use in facilitating automotive safety and taking corrective action, in accordance with an example embodiment.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” or “in another example embodiment” (and variations thereof) as used herein does not necessarily refer to a different embodiment. It is intended, for example, that claimed subject matter include combinations of example embodiments in whole or in part.

In general, terminology may be understood, at least in part, from usage in context. For example, terms, such as “and”, “or”, or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a”, “an”, or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

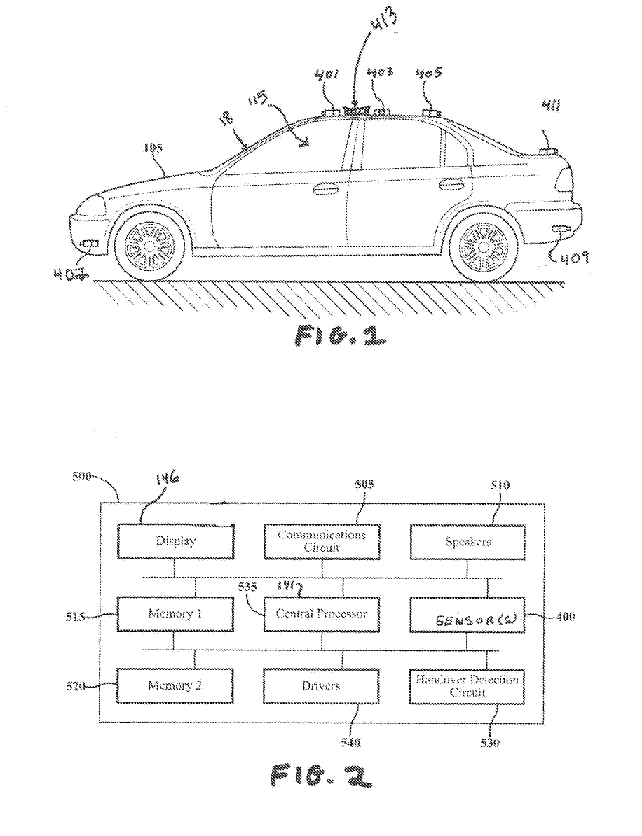

FIG. 1 illustrates an example of a vehicle 105 equipped with a group 400 of sensors 401, 403, 405, 407, 409 and 411 in accordance with an example embodiment. The sensors can be positioned along any suitable portion of the vehicle 105 to enable the cameras sensors to detect and identify at least one other vehicle (not shown in FIG. 1) in the vicinity of the vehicle 105. Note that as utilized herein, the term “vehicle” can be defined as a conveyance that provides transport to humans, animals, machines, cargo, or other objects. An “occupant” is defined as a person, animal, or machine that is transported or transportable by a vehicle. In view of this definition, a person, animal, or machine may be considered an occupant when inside the vehicle or outside the vehicle. Thus, an occupant may be, for example, a vehicle driver or a vehicle passenger.

In a preferred embodiment, the sensors 401, 403, 405, 407, 409 and 411 can be implemented as cameras that take video of the environment external to the vehicle 105. However, in some example embodiments, as discussed in greater detail herein, such sensors can include, for example, LIDAR sensors, RADAR sensors, GPS sensors, temperature sensors, pressure sensors, motions sensors, orientation sensors and so on. Thus, for example, sensor 401 and 403 may be cameras, while sensors 405 and 411 may be implemented as LIDAR or RADAR sensors and so on. In other embodiments, sensor 401 may be a camera while sensor 403 may be a motion sensor or an orientation sensor. Thus sensors 401, 403, 405, 407, 409 and 411 as a group of sensors of varying type and purpose, but which may be detect data that is usable for purposes of detecting conditions or changes in conditions external to the vehicle 105.

In the case of a camera, such cameras may feed video signals to a section of a passenger-compartment display 146 (see FIG. 2) that corresponds to the area of the outside environment to be displayed on that section. For example, cameras that take video of the front of the vehicle 105 may provide video streams to the section of the passenger-compartment display 146 that is placed in the area where the front windshield would normally be.

In an example embodiment, one or more of the cameras may include the ability to adjust its magnification when capturing images (i.e., zoom-in or zoom-out). Moreover, such cameras may be in fixed positions or may be pivotable or repositioned on the vehicle. Although the sensors 401, 403, 405, 407, 409, 411 are shown on the exterior of the vehicle 105, one or more of them may be positioned inside the passenger compartment 115, with appropriate accommodations made to allow the cameras to have substantially unobstructed views of the outside environment.

The vehicle itself may be, for example, a connected vehicle or an autonomous vehicle. The term “connected vehicle” as utilized herein refers to a vehicle that is equipped with Internet access, and usually also with a wireless local area network. This allows the car to share Internet access with other devices both inside as well as outside the vehicle. A connected vehicle allows the vehicle to share internet access with other devices both inside as well as outside the vehicle. The connected vehicle can be outfitted with special technologies that tap into the Internet or a wireless LAN and provides additional benefits to the occupant. For safety-critical applications, the connected vehicle can be connected using Dedicated Short Range Communication (DSRC) radios, operating in the FCC-granted 5.9 GHz band with very low latency.

A connected vehicle may or may not be an autonomous vehicle. An “autonomous vehicle” can be defined herein as a vehicle that is configured to sense its environment and navigate itself with or without human interaction. An autonomous vehicle may operate in one or more modes, including a fully autonomous mode, a semi-autonomous (for example, adaptive cruise control) mode, or in a manual mode (e.g., the human operator/driver has control of the vehicle). The term “operational hazard” refers a hazard, danger, or risk, either currently in existence or with the potential of existing, that is involved with the operation of an autonomous vehicle. Examples of an operational hazard include objects in the path of the vehicle, changes in the course of a road on which the vehicle is traveling, malfunctions of components or systems of the vehicle, or certain operational modes of the vehicle. A “display” can be defined as an electronic device that is configured to show images or otherwise make them visible. A vehicle may also be semi-autonomous. That is, in some instances or mode, the vehicle may operate as vehicle driven by a driver whereas in other situations the same vehicle may be function as a complete autonomous vehicle.

In some example embodiments, the vehicle 413 can be equipped with a satellite antenna 413 for receiving satellite signals from one or more satellites. In some situations, such a satellite antenna 413 can be configured as a satellite terminal that relies on a beam-steering antenna design based on synthetic metamaterials, which can bend electromagnetic waves in ways that natural materials cannot. In this example, antenna 412 may be configured as a flat antenna about the size and shape of a laptop computer, and can be equipped with an array of metamaterial elements that can be electronically tuned to maintain a satellite connection.

Referring to FIG. 2, an example of a block diagram of a systems layer 500 is illustrated. The systems layer 500 may be representative of and may include at least some of the components described herein, although the systems layer 500 is not necessarily limited to those components. The description associated with FIG. 2 may expand on some of the components and processes presented in the discussion herein, although the additional explanations here are not meant to be limiting.

In one arrangement, the systems layer 500 can include any number of hardware and software components to enable the operation of at least some features of the vehicle 105. As an example, the systems layer 500 can include display 146, which in some example embodiments may be a passenger-compartment display. The systems layer 500 can further include a communications circuit 505, a set of speakers 510, a first memory 515, a second memory 520, a handover-detection circuit 530, a central processor 141, a set of drivers 540, and the group of sensors 400 that include, for example, the sensors 401, 403, 405, 407, 409, 411 shown in FIG. 1. Although not shown here, the systems layer 500 can include or be configured to interact with any number of layers to support and facilitate communications with higher levels of the vehicle 105.

Note that as utilized herein the term “processor” can be defined as a hardware component or group of hardware components that are configured to execute instructions or are programmed with instructions for execution (or both), and examples include single and multi-core processors and co-processors. The term “communications circuit” can be defined as one or more circuit components that are configured to support or otherwise facilitate the exchange of communication signals, including through wired connections, wireless connections, or both. A “memory” or a “memory unit” can be defined as a non-transitory hardware structure (along with supporting software or file systems, where necessary for operation) that is configured to store a collection of data that is organized for access. A “camera” can be defined as any device, component, and/or system that can capture or record images.

The communications circuit 505 can include any suitable number and type of components for conducting communications in accordance with a specific frequency (or range of frequencies) and/or one or more particular communication protocols. For example, the communications circuit 505 may be configured to conduct satellite communications, which can be used to support GPS or other directional assistance systems. As another example, the communications circuit 505 may be designed for Bluetooth, Near Field Communication (NFC) or Wi-Fi communications, relatively short-range protocols that enable wireless communications with other communications equipment associated with the operation of the vehicle 105. The communications circuit 505 may also be set up to facilitate wireless communications over a cellular communications network, which can enable a user to make voice calls and perform data exchanges over such wide-area networks. An occupant may also conduct wide-area network communications through a portable computing device when the device is docked with the communications circuit 505, either through a hard-wired or wireless connection. Other protocols and types of communications may be supported by the communications circuit 505, as the vehicle 105 is not limited to these particular examples described here.

The speakers 510 may also be used to broadcast any relevant audio, including alerts as discussed herein. This output may supplement the information shown by the passenger-compartment display 110, or it may be in lieu of the images being displayed. The term “speaker” is defined as one or more devices, components, or systems that produce sound, whether audible to humans or not, in response to an audio signal input. In addition to providing warnings, the speakers 510 may broadcast sounds related to other functions of the vehicle 105, such as audible directions from a GPS or music from a stereo system.

The first memory 515 and the second memory 520 can include any number and type of hardware units for storing data. As an example, the first memory units 515 and the second memory 520 may non-transitively store instructions and other programs to enable at least some of the components, devices, and systems of the vehicle 105 to perform their functions. As an example, the first memory 515 can be volatile memory, and the second memory 520 can be non-volatile memory. Suitable examples for the first memory 515 and the second memory 520 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The first memory 515 and/or the second memory 520 may be a component of the central processor 535, or the first memory 515 and/or the second memory 520 can be communicatively connected to the central processor 360 (and any other suitable devices) for use thereby.

The handover-detection circuit 530 can include any number of components for detecting a handover event associated with the operation of the vehicle 105. A “handover event” is defined as any event that indicates a shift to manual mode is desired or required or that at least some input or control over the vehicle 105 from a human is desired or required. For example, various sensors (not shown) of the vehicle 105 may detect obstacles in the travel path of the vehicle 105 or a loss of positional information from a GPS. This information may be provided to the handover-detection circuit 530, which can generate a signal that is indicative of a handover event. In one embodiment, the handover-detection circuit 530 may forward this signal to the central processor 535 to enable additional actions to be taken in response to the handover event.

The central processor 141 can be configured to exchange signals with any number of systems or components of the vehicle 105 and can execute programs or other instructions to process the received data. The central processor 141 may request additional data from other resources and can provide output to the other devices of the systems layer 500 or other systems of the vehicle 105.

Any suitable architecture or design may be used for the central processor 141. For example, the central processor 141 may be implemented with one or more general-purpose and/or one or more special-purpose processors, either of which may include single-core or multi-core architectures. Examples of suitable processors include microprocessors, microcontrollers, digital signal processors (DSP), and other circuitry that can execute software. Further examples of suitable processors include, but are not limited to, an array processor, a vector processor, a field-programmable gate array (FPGA), a programmable logic array (PLA), an application specific integrated circuit (ASIC), and programmable logic circuitry. The central processor 535 can include at least one hardware circuit (e.g., an integrated circuit) configured to carry out instructions contained in program code.

In arrangements in which there is a plurality of central processors 141, such processors can work independently from each other or one or more processors can work in combination with each other. In one or more arrangements, the central processor 141 can be a main processor of the systems layer 500 or the vehicle 105. This description about processors may apply to any other processor that may be part of any system or component described herein.

The drivers 540 can be software modules to enable any of the devices of the systems layer 500 to communicate with higher level layers. For example, the passenger-compartment display 146 can include any number of drivers to facilitate its operation, such as the feature of showing many different images simultaneously. The passenger-compartment display 146 can be configure in some example embodiments with the ability to selectively display images of the outside environment of the vehicle 105 and images unrelated to the outside environment, such as multimedia content or operational information.

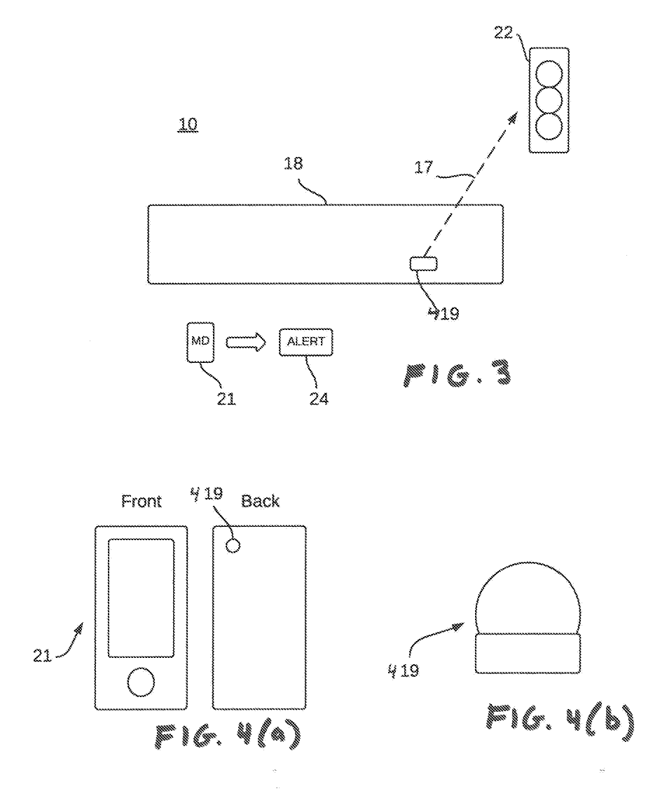

FIG. 3 illustrates a schematic diagram of a system 10 for providing alerts to an occupant of a vehicle (e.g., a vehicle driver and/or passenger) via wireless communications, in accordance with an example embodiment. System 10 generally monitors one or more conditions with respect to the vehicle 105, such as, for example, environmental conditions (e.g., weather conditions, temperature, pressure, etc) and the speed and trajectory of other vehicles within the vicinity of the vehicle 105 while the vehicle 105 is in motion or is stopped.

The conditions monitored by system 10 may be external to the vehicle or internal depending upon the application or need. In the example shown in FIG. 3, the change in condition is depicted a change in the color of a traffic light 22. A sensor 419 (e.g., a video camera) is shown in FIG. 3 as located on a dashboard with respect to a front vehicle windshield 18 of the vehicle 105. For example, the traffic light 22 may change from red to green and an alert 24 is issued alerting the driver and/or a passenger of the the vehicle 105 regarding a change in color when a change in the condition (i.e., change in color, in this case) is detected.

Note that as utilized herein the term “change in the condition” or “change in a condition” can refer to changes in conditions external to the vehicle 105, such as, for example, movement, including changes in speed and trajectory of vehicles nearby or approaching or leaving, changes in weather, changes in temperature, changes in pressure, and so on. In the example shown in FIG. 3, the monitoring activity (e.g., monitoring the traffic light 22) is indicated in FIG. 3 by a dashed arrow 17. As will be discussed in greater detail herein, such monitoring activity can be facilitated by sensors such as sensors sensors 401, 403, 405, 407, 409, 411 and/or 419 and other components and modules.

In some example embodiments, the alert 24 may be transmitted wirelessly to, for example, a user's mobile electronic wireless computing device 21 (e.g., a smartphone, tablet computing device, smartwatch, wearable device, etc.) or to a device or system (e.g., an in-vehicle computing system) integrated with the vehicle. Note that electronic devices such as smartphones, smartwatches, personal digital assistants (PDAs) mobile telephones, tablet devices, laptops and other Internet connectivity devices (“mobile stations”) provide users with mobile access to various information resources. Such mobile stations generally operate via a cellular 3G or 4G broadband data communication standard and/or a WIFI network connection to a local area network.

In FIG. 3 the computing device is shown as a MD (Mobile Device) 21. It can be appreciated, however, that in some example embodiments, the computing device can be a computing device such as an integrated in-vehicle computing device, a mobile device or a combination an integrated in-vehicle computing device and a mobile device such as MD 21 in bidirectional packet based wireless communication (or direct communication via, for example, a USB wired connection) with one another (e.g., Bluetooth wireless communications, 802.11 wireless communications, cellular communications, etc). In still other example embodiments, the MD 21 can communicate with a system such as system 500 through the use of a communications circuit 505 and/or other communications circuits and modules.

In the example embodiment shown in FIG. 3, the monitoring activity (e.g., monitoring the traffic light or other conditions such as pedestrian movement) can be facilitated by one or more sensors such as, for example, the sensor 419 (e.g., a video camera) which may be located on the dashboard of the vehicle with a view through the vehicle windshield 18. In such a situation, the camera may be, for example, a dashcam. A dashboard is a preferable location for such a camera, but it should be appreciated that cameras and/or other sensors may be located in other positions within and/or external to the vehicle 105, such as in the front of the vehicle near or by back or front bumper. In the example depicted in FIG. 3, only a single camera is shown. In other example embodiments, however, more than one camera may be implemented in the context of the vehicle 105 along with other types of sensors. In other words, in some example embodiments, multiple sensors may be deployed on the vehicle (within the vehicle passenger compartment and/or external to the passenger compartment on the vehicle body). In the FIG. 3 scenario, the sensor 419 is shown monitoring the external condition (e.g., traffic light 22 changing color) through the windshield 18.

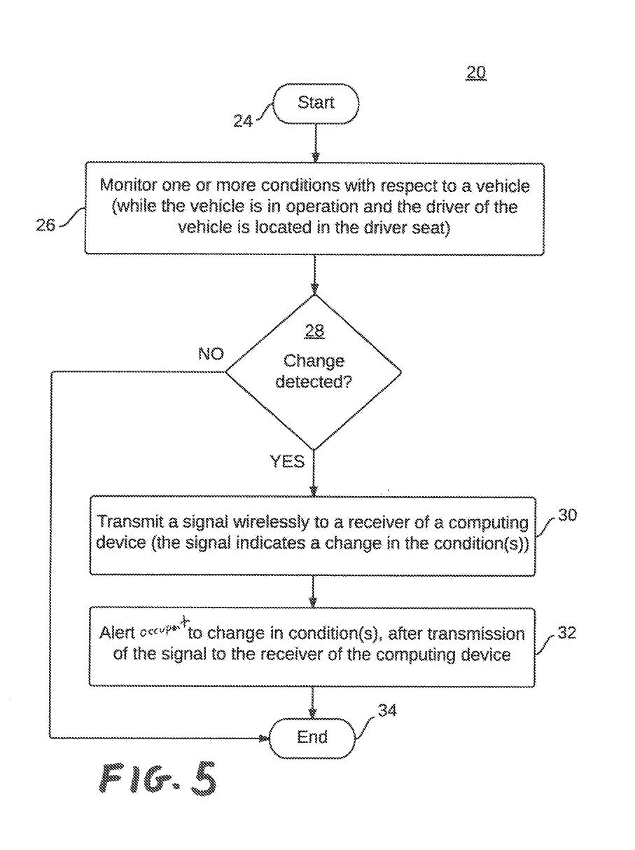

FIG. 4(a) illustrates an example computing device 21, which is shown as a smartphone implementation. It can be appreciated, however, that the computing device 21 can be implemented as other types of wireless mobile devices, such as a tablet computing device, and wearable devices such as a smartwatch. A non-limiting example of a wearable device such as a smartwatch, which can be utilized as computing device 21 is depicted in U.S. Pat. No. 8,854,925 entitled “Smart Watch and Control Method for the Same,” which issued on Oct. 7, 2014 and is incorporated herein by reference. Another non-limiting example of a smartwatch that can be adapted for use as computing device 21 is disclosed in U.S. Pat. No. 8,279,716 entitled “Smart-Watch including Rip-Up Display,” which issued on Oct. 2, 2012 and is incorporated herein by reference. Note that the terms “smart watch” and “smartwatch” and “smart-watch) can be utilized interchangeably to refer to the same type of device.

Another example of a wearable device that can be implemented as computing device 21 is an OHMD (Optical Head-Mounted Display) that can be equipped with a video camera. OHMD is a wearable display that has the capability of reflecting projected images as well as allowing the user to see through it that is augmented reality. A non-limiting example of an OHMD and related components and systems, which can be adapted for use as computing device is disclosed in U.S. Patent Application Publication No. 20170257594, entitled “Systems and Methods for Tracking Objects for Augumented Reality,” which published on Sep. 7, 2017, and is incorporated herein by reference in its entirety.

The computing device 21 can incorporate a video camera 419. In some example embodiments, the example computing device 21 with camera 419 may be implemented in the context of, for example, a smartphone or tablet computing device located or mounted on the vehicle dashboard or elsewhere within the vehicle (or located on the vehicle external to the passenger compartment). The alert 24 may be broadcast as an audio alert or text alert message through the computing device 21. In some example embodiments, the alert can be transmitted in the context of a voice alert, which is discussed further herein.

In another example embodiment, the camera 419 may be implemented as a standalone camera that communicates wirelessly with the computing device 21 via wireless communications as described in greater detail herein. FIG. 4(b) illustrates an example camera 419, which may be located in an optimal location with the vehicle for monitoring conditions external to the vehicle, in accordance with another embodiment. In the FIG. 4(b) example, the camera 149 may communicate wirelessly with the computing device 21. One non-limiting example of a video camera which may adapted for use as, for example, camera 419 shown in FIG. 4(b), is disclosed in U.S. Patent Application Publication No. 20140047143 entitled “Wireless video camera and connection methods including a USB emulation,” which issued on Feb. 13, 2014 and is incorporated herein by reference in its entirety. Another non-limiting example of a video camera that can be utilized to implement the sensor (camera) 419 shown in FIG. 3 and FIG. 4(b) is disclosed in U.S. Patent Application Publication No. 20170249515 entitled “Video Camera Device and System Using Recursive Neural Networks and Future Event Prediction,” which published on Aug. 31, 2017 and is incorporated herein by reference in its entirety.

The sensor 419 shown in FIG. 3 may be implemented as, for example, a dashcam (or dash cam). A dashcam (dashboard camera) is an onboard camera that attaches to the vehicle's interior windscreen by either a supplied suction cup mount or an adhesive-tape mount. It can also be positioned on top of the dashboard or attached to the rear-view mirror with a special mount. It continuously records the road ahead while the vehicle is in motion. Various types of dashcam can be implemented as sensor 419, ranging from basic video cameras to those capable of recording parameters such as date/time, speed, G-forces and location. In some example embodiments, the sensor or camera 419 may be implemented as a wearable video camera that monitors conditions external to the vehicle or within the vehicle. Such a video camera may be, for example, a lapel camera worn by a the vehicle driver and/or a passenger.

FIG. 5 illustrates a method 20 for alerting a vehicle occupant via wireless communications, in accordance with an embodiment. As indicated at block 24, the process begins. Thereafter, as shown at block 26, a step or logical operation can be implemented for monitoring one or more conditions external to the vehicle and such monitoring can be optionally limited to a period in which the vehicle is in operation and the driver of the vehicle is located in the vehicle's driver's seat.

Note that such a monitoring step or logical operation can involve monitoring the condition (or multiple conditions) with one or more sensors such as, for example, the sensors 401, 403, 405, 407, 409 and 411 discussed previously with respect to FIGS. 1-2 and/or the camera/sensor 419 discussed previously with respect to FIG. 3 and FIGS. 4(a) to 4(b). Such sensors can communicate with a computing device or computing system such as system 500 and/or with individual computing devices such as the smartphone 21 shown in FIG. 4(a). In some examples, the sensor/camera may be integrated with the computing device (e.g., a Smartphone or tablet computer). In other example embodiments, such a camera may be provided as a standalone camera positioned within the vehicle (or mounted on the vehicle body such as on or integrated with a bumper, a door, a vehicle light, and so on) to monitor the condition and the camera may also communicate via a wireless connection (e.g., Bluetooth or other wireless communications as discussed in greater detail herein) with the computing device.

Monitoring can involve the use of object recognition or other video image recognition techniques and systems. For example, in one embodiment a traffic recognition approach can be utilized as part of the video monitoring operation. One example of a traffic object recognition approach that can be adapted for use in accordance with an embodiment is disclosed in U.S. Patent Application Publication No. 2011/0184895 entitled “Traffic Object Recognition System, Method for Recognizing a Traffic Object, and Method for Setting up a Traffic Object Recognition System,” which published to Janssen on Jul. 28, 2011 and is incorporated herein by reference in its entirety. Another object recognition approach that can be adapted for use in accordance with an alternative embodiment is disclosed in U.S. Pat. No. 8,447,139 entitled “Object recognition using Haar features and histograms of oriented gradients,” which issued on May 21, 2013 and is incorporate herein by reference in its entirety.

Next, as illustrated at decision block 28, a test can be performed to determine if a change has been detected the monitored conditions (or conditions). If a change is detected, then as disclosed at block 30, a step or logical operation can be implemented for transmitting a signal wirelessly to a computing device, wherein such a signal indicative of the change in the condition(s) monitored. Thereafter, as shown at block 32, a step or logical operation can be implemented to alert the occupant of the vehicle 105 of the change in the condition after transmission of the signal to the computing device.

It can be appreciated that the vehicle in operation may be, for example, temporarily stopped (e.g., at an intersection/stop light, a parking lot, in traffic, etc.) or in motion. In some implementations, the computing device that receives and plays the alert (e.g., an audio signal or voice announcement) may be, for example, a smartphone or a tablet computing device. In other embodiments, the computing device may be integrated with the vehicle as part of an in-vehicle system that provides alerts and other information (e.g., GPS information) to the vehicle's occupants.

Such a system typically includes a dashboard display. One example of a non-limiting in-vehicle system that can be adapted for use in accordance with an alternative embodiment is disclosed in US Patent Application Publication No. 20110034128 entitled “Mobile Communication Device Linked to In-Vehicle System,” which published on Feb. 10, 2011 and is incorporated herein by reference in its entirety. Yet another example of a non-limiting in-vehicle system that can be adapted for use in accordance with an alternative embodiment is disclosed in U.S. Pat. No. 8,417,211 entitled “In-Vehicle System (IVS) Control of Emergency Data Communications,” which issued on Apr. 9, 2013 and is incorporated herein by reference in its entirety.

It can also be appreciated that the in the context of a tablet or smartphone implementation, the computing device may not necessarily belong to the vehicle driver but may, for example, be a computing device (e.g., hand held wireless electronic device, smartphone, tablet, etc.) belonging to passengers.

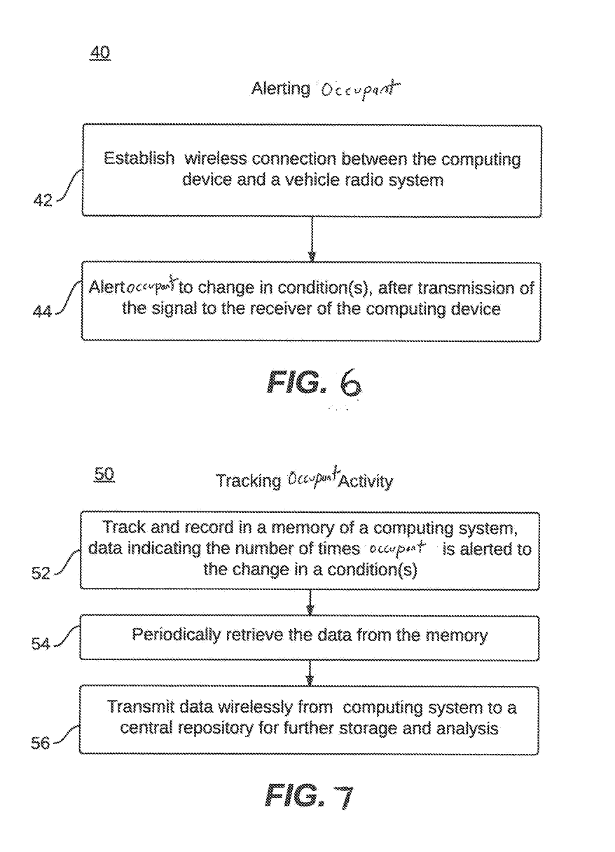

FIG. 6 illustrates a method 40 for alerting a vehicle occupant, in accordance with an alternative embodiment. In some example embodiments, the step or logical operation of alerting the occupant of the change in condition after transmission of the signal to computing device, can further involve providing an audible alert to the vehicle occupant via a speaker associated with the computing device, wherein the audible alert indicative of the change in the monitored condition. Such an alerting operation may involve establishing a wireless connection between the computing device and a radio system of the vehicle as shown at block 42, and providing the audible alert from the computing device via the radio system, as indicated at block 44. An example of the speaker is the speaker or speaker(s) 510 shown in FIG. 2.

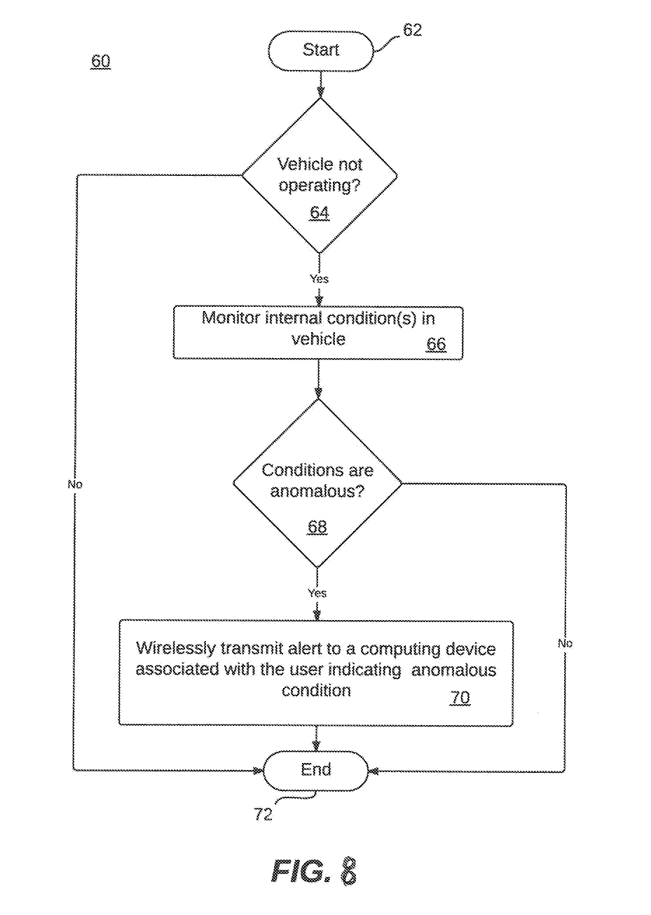

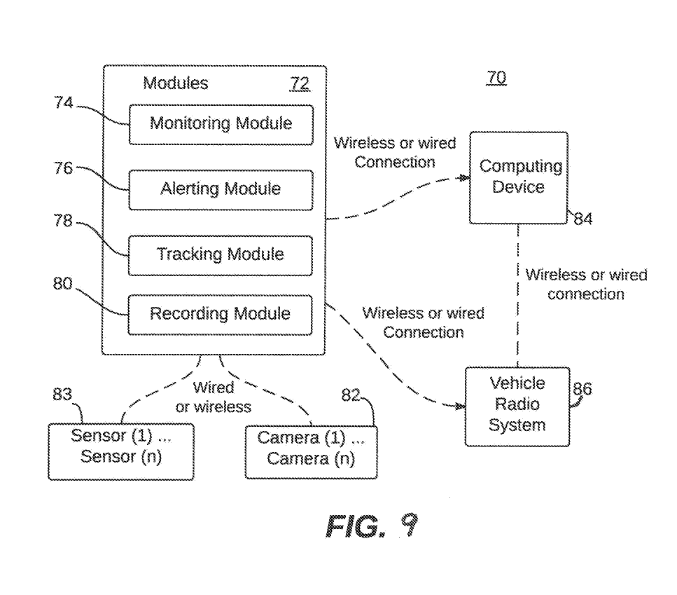

FIG. 7 illustrates a method 50 for tracking a vehicle occupant's activity, in accordance with an alternative embodiment. It can be appreciated that in some example embodiments, the disclosed monitoring method/system can be modified to monitor not just external conditions or activities, but the activity of the occupant itself in order to track, for example, in the case of a driver, driver inattentiveness. As depicted at block 52, a step or logical operation can be implemented for tracking and recording in a memory of a computing system data indicative of the number of times the occupant (e.g. a vehicle driver and/or a vehicle passenger) is alerted to a change a condition. Then, as shown at block 54, a step or logical operation can be implemented to periodically retrieve such data from the memory, and as shown at block 56, transmit such data wirelessly from the computing system to a central repository for further storage and analysis. Such data (e.g., telematics, telematics data, etc) may be useful, for example, for insurance companies, including insurance companies involved in the UBI (Usage-Based Insurance) industry.

FIG. 8 illustrates a method 60 for monitoring conditions with respect to a vehicle, in accordance with an alternative embodiment. As indicated at block 62, the process is initiated. Thereafter, as depicted at decision block 64, a test can be performed to determine if the vehicle is in operation. If it is determined that the vehicle is in operation, then the process ends, as shown at block 72. If it is determined that the vehicle is no longer in operation (e.g., the key is removed from the ignition), then as indicated at block 66, conditions within the vehicle are monitored. For example, sensors as discussed previously herein may monitor conditions within the vehicle or external to the vehicle. For example, some sensors may be located within the vehicle such as temperature and/or pressure sensors along with, for example, one or more in-vehicle video cameras that monitor and scan the interior of the the vehicle.

As depicted at block 68, a test can be performed to determine if conditions are anomalous. Anomalous conditions may include one of a variety of possible conditions. For example, an anomalous condition may be a change in temperature in the vehicle. Another anomalous condition may be, for example, the presence of someone in the vehicle who normally would not still be in the vehicle after the car is turned off or, for example, the vehicle doors are closed and/or locked. Another type of anomalous condition may be conditions that are external to the vehicle and which are monitored and detected through various sensors located on the external body of the vehicle. For example, vehicle traffic flow external to the vehicle may be monitored by such sensors and an anomalous change in the conditions of such traffic flow (e.g., change in overall traffic speed flow) may be a type of anomalous condition.

If an anomalous condition is detected, then as indicated at block 70, an alert may be wirelessly transmitted to a computing device associated with a user (e.g., a vehicle driver, a vehicle passenger, etc.) indicating such an anomalous condition. It can be appreciated that in some example embodiments, the alert or alerts can be provided to the vehicle driver, a vehicle passenger and/or both (i.e., in other words, to the vehicle's occupant or occupants). In autonomous or self-driving vehicles, such alerts may be transmitted to a passenger in the self-driving vehicle. The process can then terminate, as depicted at block 72. Note that in some example embodiments, such an alert may be wirelessly transmitted as a text message to the computing device via a wireless network. Such a wireless network can be, for example, a cellular telephone network and/or a WiFi network.

A text message alert can be implemented via for example, Short Message Service (SMS), SkyMail, Short Mail, Instant Messaging (IM), chat, Mobile Instant Messaging (MiM), Multimedia Messaging Service (MMS), and other messaging services. Text messaging is supported by computer devices such as laptop computers, desktop computers, handheld computers, and wireless devices such as cellular telephones, Wireless Local Area Network (WLAN) terminals, Wireless Wide Area Network (WWAN) terminals, and Wireless Personal Area Network (WPAN) terminals, for example.

Typically, a text message server serves as an intermediate device for receiving a text message from a source device, storing the text message, and forwarding the text message to a recipient device, e.g., a first cell phone as a source device and a second cell phone as a recipient device. While some text message service providers charge for text message support, e.g., cellular networks, other text message service providers support text messaging without charge. Various protocols such as SS7, GSM MAP, or TCP/IP, for example, may be employed to support text messaging.

In some example embodiments, the alert regarding a change in condition can be implemented in the context of a notification service. In one example, the text message may be sent as a push notification across a cellular or wireless communication network to the computing device. Certain text messaging protocols may be used, such as, mobile short message service (SMS), multimedia message service (MMS), and instant messaging (IM), or any other related text application. The communication medium may include transferring information over communication links, such as wireless networks (e.g., GSM, CDMA, 3G, 4G, etc.), wireline networks (e.g., landline telephony), Internet, satellite/cable networks, or, any other data medium using standard communication protocols.

An example of a notification service that can be adapted for use with an alternative embodiment is disclosed in U.S. Pat. No. 8,751,602 entitled “Method and Apparatus of Providing Notification Services to Smartphone Devices,” which issued on Jun. 10, 2014 and is incorporated herein by reference in its entirety. Another non-limiting example of a system that can be adapted for use in accordance with an alternative embodiment for delivery of an alert regarding a change in condition is disclosed in U.S. Pat. No. 8,265,938 entitled “Voice Alert Methods, Systems and Processor-Readable Media,” which issued on Sep. 11, 2012 and is incorporated herein by reference in its entirety.

One possible example of a situation where the method 60 is useful is the case of a child accidentally being left in a vehicle during hot weather. A camera in the vehicle operating via battery power or residual electricity from the vehicle electrical system may detect an anomaly such as the child in a rear car seat. The anomaly in this case would be the presence (e.g., detection of the child moving, turning his or her head, moving his or her arms, legs, etc.) of a child in a car seat, wherein a child would not normally be in the car seat after the car is no longer in operation and/or after the doors are closed/locked, and/or after a particular amount of time (e.g., 5 minutes, 10 minutes, etc.). Note that a cellular network or cellular link or service such as OnStar can be utilized for sending out an alert (e.g., text message, audio alert) etc. to let them know that a child may have been left in a car seat.

Audio sensors may also be employed to detect, for example, the sound of a crying child. A temperature sensor could also be utilized to detect a rise in temperature to an unsafe level for humans and when that temperature threshold is met, the alert is transmitted wirelessly to the user's hand held device (e.g., smartphone, tablet, smartwatch or other wearable device, etc.). Such an approach could thus be utilized to prevent tragic and unnecessary deaths in automobiles due to heatstroke.

Note that the step or logical operation of anomaly detection or outlier detection shown in block 68 can involve the identification of items, events or observations which may not conform to an expected pattern or other items in a dataset. Anomalies are also referred to as outliers, novelties, noise, deviations and exceptions. In the context of abuse and network intrusion detection, “interesting” objects are often not rare objects, but unexpected bursts in activity. This pattern does not adhere to the common statistical definition of an outlier as a rare object, and many outlier detection methods (in particular unsupervised methods) will fail on such data, unless it has been aggregated appropriately. Instead, a cluster analysis algorithm may be able to detect the micro clusters formed by these patterns.

The anomaly detection operation shown at block 68 can preferably be implemented by an anomaly detection mechanism based on a number of possible categories of anomaly detection including but not limited to, unsupervised anomaly detection, supervised anomaly detection, semi-supervised anomaly detection, etc. An unsupervised anomaly detection technique can be employed detect anomalies in an unlabeled test data set under the assumption that the majority of the instances in the data set are normal by looking for instances that seem to fit least to the remainder of the data set. Alternatively, a supervised anomaly detection technique may be employed, which requires a data set that has been labeled as “normal” and “abnormal” and involves training a classifier (the key difference to many other statistical classification problems is the inherent unbalanced nature of outlier detection). Semi-supervised anomaly detection techniques may also be employed, which construct a model representing normal behavior from a given normal training data set, and then testing the likelihood of a test instance to be generated by the learnt model.

FIG. 9 illustrates a schematic diagram of a system 70 for alerting a vehicle driver via wireless communications, in accordance with an alternative embodiment. System 70 includes a module (or group of modules) 72 including a monitoring module 74, an alerting module 76, a tracking module 78, and a recording module 80. Module 72 can communicate wirelessly with a computing device 84 (e.g., a driver/passenger smartphone, tablet computer, etc.), which in turn can communicate wirelessly with the vehicle radio system 86. Note that the computing device 84 may be a computing device such as a driver/passenger smartphone, tablet computer, etc. An example of such a computing device is the computing device 21 shown in FIG. 4(a). The computing device can also be in some example embodiments, a computing system such as, for example, the system 500 of FIG. 2. In still other example embodiments, the computing device 84 can be, for example, a computer server or another computing system such as an integrated in-vehicle computer.

One or more sensor(s) 83 can communicate with module 72 and one or more camera(s) 82 may communicate with the module 72. The sensor(s) 83 and the camera(s) 82 can communicate with module 72 via wireless or wired communications. Note that the camera (or cameras) 82 are similar or analogous to the cameras discussed previously herein. The sensors 82 are similar or analogous to the sensors discussed previously herein.

The monitoring module 74 can be configured with instructions for performing varying scanning, determination and estimation and/or correlation activities. The monitoring module 74 can, for example, scan and monitor the area around the vehicle 105 for other vehicles and objects and identify such vehicles and objects with respect to the vehicle 105. In addition, the monitoring module 74 can include steps/operations or instructions for determining if the other identified vehicle or vehicles are in motion with respect to the vehicle 105 in which the user or occupant of the 105 vehicle is located, in response to identifying the other vehicle(s) with respect to the vehicle 105. The monitoring module 74 can further include steps/operations or instructions for identifying the type of other vehicles. As indicated previously, identifying other objects or vehicles can occur through feature extraction and machine learning techniques. The monitoring module 74 can also be configured with instructions for estimating the speed and the trajectory of the other identified vehicles/objects and the environmental condition (e.g., the weather) surrounding the vehicle 74. In addition, the monitoring module 74 or the tracking module 78 can be configured with instructions for correlating the speed and the trajectory of the other identified vehicle(s) with the environmental condition and the type of identified vehicle. This information can be then used to generate data indicative of the speed and the trajectory of the other vehicles or objects with respect to the vehicle 105, which takes into account the environmental condition and the type of identified vehicle(s). The alerting module 76 can be configured with instructions for actually generating an alert indicative of the aforementioned speed and trajectory of the other vehicle with respect to the vehicle 105 in which the occupant is located, based on the aforementioned generated data.

As indicated previously, examples of sensors that can be utilized to implement sensor(s) 83 are sensors such as temperature sensors, pressure sensors, velocity sensors, acceleration sensors, vehicle heading sensors, yaw-rate sensors, GPS sensors, and so on. One example of a vehicle heading sensor approach that can be adapted for use as or with sensor(s) 83 in accordance with an alternative embodiment, is disclosed in U.S. Pat. No. 7,957,897 entitled “GPS-based in-vehicle sensor calibration algorithm,” which issued on Jun. 7, 2011 and is incorporated herein by reference in its entirety. The GPS module discussed herein can be utilized in association with such sensors to provide location or position data with respect to the vehicle and also provide vehicle heading sensor data.

Note that in some example embodiments, the computing device 84 can communicate with the vehicle radio system via wireless communications established via Secure Simple Pairing (SSP). The sensor(s) 83 and the camera(s) 82 and the computing device 84 may also in some example embodiments communicate with module 72 via SSP. SSP, which requires less user interaction utilizes a one-time six-digit key displays at the time of pairing on both the device and the car, replacing the PIN code. Once the user confirms that the keys match, the two devices can be paired.

The monitoring module 74 can implement the monitoring steps or operations discussed previously. For example, monitoring module 74 can monitor traffic lights or other conditions (i.e., conditions external to the vehicle or within the vehicle) facilitated by, for example, camera(s) 82 and/or sensor(s) 83. The monitoring module 74 can be, for example, an anomaly detection mechanism that detects changes in conditions as discussed previously.

The alerting module 76 serves to alert the driver of the detected change in a condition. The alert (e.g., an audio alert, a text message, etc.) can be broadcast through, for example, the computing device 84 or the vehicle radio system 86 (assuming the vehicle radio system 86 is paired with the computing device 84). The tracking module 78 and the recording module 80 function to respectively track and record in a memory of a computing system (e.g., the computing device 84, an onboard computing system, etc.) data indicative of, for example, the number of times the driver is alerted to changes in conditions. Such data can be retrieved from the computer memory and then transmitted to, for example, a central repository for further storage and analysis.

It can be appreciated that in some cases, the connections between the various components shown in FIG. 9 may be implemented via wireless communications and/or wired connections. For example, the module 72 can be stored and retrieved from a computer memory which may be, for example, a memory of computing device 84, a memory of an integrated in-vehicle computing system, and/or a remote computing device or system such as a remote server. Wireless communications can occur through a wireless network such as an in-car PAN (Personal Area Network) including Bluetooth communications, or other communications means such as, for example, a cellular network.

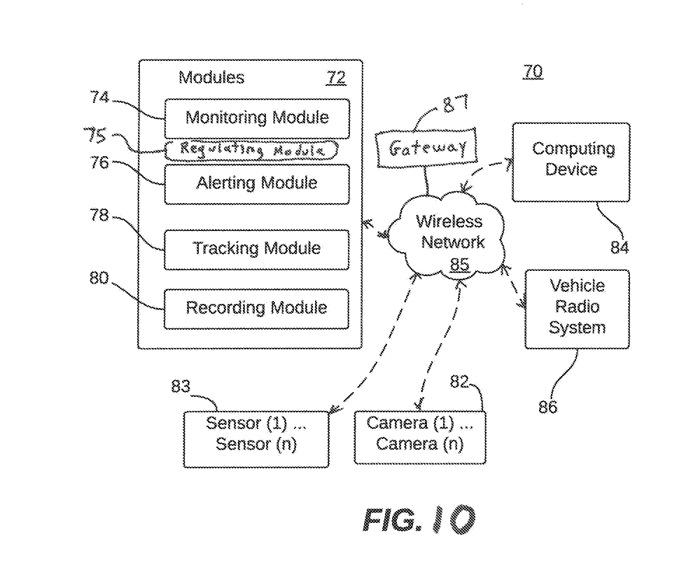

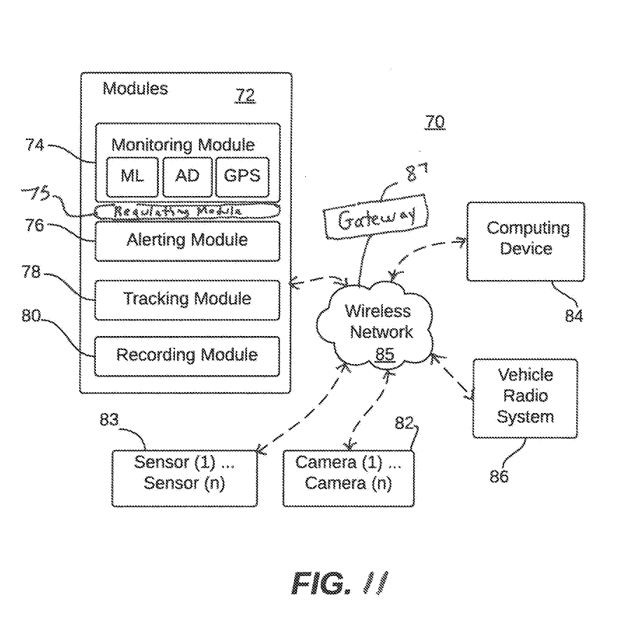

FIG. 10 illustrates a schematic diagram of a system 70 for alerting a vehicle driver via wireless communications, in accordance with an alternative embodiment. System 70 shown in FIG. 10 is an alternative version of system 70 depicted in FIG. 9. The embodiment shown in FIG. 10 includes similar or identical components to the FIG. 9 embodiment with some slight variations and additional features.

For example, FIG. 10 depicts a wireless network 85 through which the various components such as the computing device 84, the vehicle radio system 86, the module(s) 72, sensor(s) 83 and/or camera 82 can communicate with one another. In one embodiment, for example, the wireless network 85 may implement an in vehicle Bluetooth wireless communications system. The wireless network 85 is preferably a bidirectional packet based wireless communications network such as, for example, a cellular communications network or a WiFi type wireless communications network or a combination thereof.

The wireless network 85 can couple devices so that communications may be exchanged, such as between a server and a client device or other types of devices, including between wireless devices coupled via a wired or wireless network, for example. A network may also include mass storage, such as network-attached storage (NAS), a storage area network (SAN), or other forms of computer or machine-readable media, for example. A network may include the Internet, one or more local area networks (LANs), one or more wide area networks (WANs), wire-line type connections, wireless type connections, or any combination thereof. Likewise, sub-networks may employ differing architectures or may be compliant or compatible with differing protocols, and may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

The wireless network 85 may couple client devices with the network. That is, such a wireless network may employ stand-alone ad-hoc networks, mesh networks, wireless LAN (WLAN) networks, cellular networks, or the like. A wireless network such as wireless network 110 can further include a system of terminals, gateways, routers, or the like coupled by wireless radio links, or the like, which may move freely, randomly, or organize themselves arbitrarily, such that network topology may change, at times even rapidly. A wireless network may further employ a plurality of network access technologies including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Signal packets communicated via a network, such as a network of participating digital communication networks may be compatible with or compliant with one or more protocols. The signaling formats or protocols employed may include, for example, TCP/IP, UDP, DECnet, NetBEUI, IPX, AppleTalk, or the like. Versions of the Internet Protocol (IP) may include IPv4 or IPv6.

The Internet refers to a decentralized global network of networks. The internet includes local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the internet from a user site via an access node coupled to the internet. Likewise, a signal packet may be forwarded via network nodes to a target site coupled to the network via a network access node, for example. A signal packet communicated via the internet may, for example, be routed via a path of gateways, servers, etc., that may route the signal packet in accordance with a target address and availability of a network path to the target address.

In the illustrated example, the various devices and/or components such as the computing device 84, the vehicle radio system 86, sensor(s) 83, the camera(s) 82 and so on can function as client devices with respect to the wireless network 85. A gateway component such as gateway 87 can be included as part of the wireless network 85 or can be associated with the wireless network.

Note that the term “gateway” as utilized herein can refer to a link between two computer programs or systems. Such a gateway can act as a portal between two programs allowing them to share information by communicating between protocols on a computer or between dissimilar computers. The term “gateway” as utilized herein can also refer to a piece of networking hardware in a communications network (such as network 85) that can in some cases functions as a network node equipped for interfacing with another network that uses different protocols. Such a gateway can contain devices such as protocol translators, impedance matching devices, rate converters, fault isolators, or signal translators that can facilitate system interoperability. This may require the establishment of mutually acceptable administrative procedures between both networks. Note that a protocol translation/mapping gateway may interconnect with different network protocol techniques by performing the required protocol conversions.

Note that a computer or computer program can be configured to perform the tasks of a gateway. In the example shown in FIG. 10, the gateway 87 may be implemented as a computer or a group of computers capable of communicating with the wireless network 85 and/or may be implemented as a computer program located in a memory of such a computer (or computers) which is retrievable and processable by a processor to perform various gateway functions with respect to the wireless network 85. In some example embodiments, the gateway 84 may function as a protocol converter that operates at any network later. The activities of such a gateway are similar to that of router or switch but are actually more complex than that of a router or switch because the gateway can communicate using more than one protocol.

In some example embodiments, gateway 87 can be a computer server that acts as a gateway node that also acts as proxy server and a firewall server. The gateway 87 can be associated with both a router, which knows where to direct a given packet of data that arrives at the gateway, and a switch, which furnishes the actual path in and out of the gateway for a given packet.

In other example embodiments, the gateway 87 may be implemented as an Internet of Things (IoT) Gateway, which provides the means to bridge the gap between devices in the field (e.g., vehicles, factory floor, home, etc.), the Cloud, where data is collected, stored and manipulated by enterprise applications, and the user equipment (smart phones, tablets etc.). Such an IoT gateway can provide a communication link between the vehicle 105 and/or a system such as system 500 and the Cloud and can also offer local processing and storage capabilities to provide offline services and if required real time control over the devices in the field.

Note that to achieve sustainable interoperability in the IoT ecosystem, two possible architectures for data exchange protocols can be utilized: a bus-based (DDS, REST, XMPP) and a broker based (e.g., AMPQ, CoAP, MQTT, JIM) and a broker based. The protocols that support the information exchange between interoperability domains can also be classified to message-centric (AMQP, MQTT, JMS, REST) and data-centric (DDS, CoAP, XMPP). To use the full potential of IoT the interconnected devices communicate using lightweight protocols that do not require extensive CPU resources. C, Java, Python and some scripting languages are preferable choices used by IoT applications. To handle any needed protocol conversion, database storage or decision making (e.g. collision handling), IoT nodes use separate IoT gateways in order to supplement the low-intelligence within the IoT node. Such an IoT gateway can communicate with, for example, a system such as system 500, the wireless network 85 and various IoT devices associated with a vehicle such as vehicle 105.

In a preferred example embodiment, the gateway 85 can actually be a physical hardware device located in the vehicle 105 and/or integrated with the vehicle 105 and its computing and electronic systems and which communicates with the wireless network 85. In an alternative example embodiment, the gateway 85 may be implemented as a computing device such as a server that is located in a different geographical location from the vehicle 105 (e.g., in another city or state) but which communicates via bidirectional wireless communications with the vehicle 105 or systems such as system 500 through the wireless network 85.

A regulating module 75 can be further included as part of system 70. This regulating module and monitors and regulates with a gateway component such as gateway 87, the rate of data exchanged between the client devices (e.g., computing device 84, vehicle radio system 86, sensor(s) 83, camera(s) 82, etc) and the bidirectional packet based wireless network 85 to allow for optimum data processing for such client devices and/or client systems (e.g., in the case of system 500 shown in FIG. 2). The ability to monitor and regulate the rate of data exchanged for optimization of the underlying computer systems can result in increased efficiencies in the performance and operations of not only the client devices but also the underlying in-vehicle computing system such as system 500 shown in FIG. 2 along with increased efficiencies in the performance of the vehicle (e.g., vehicle 105).

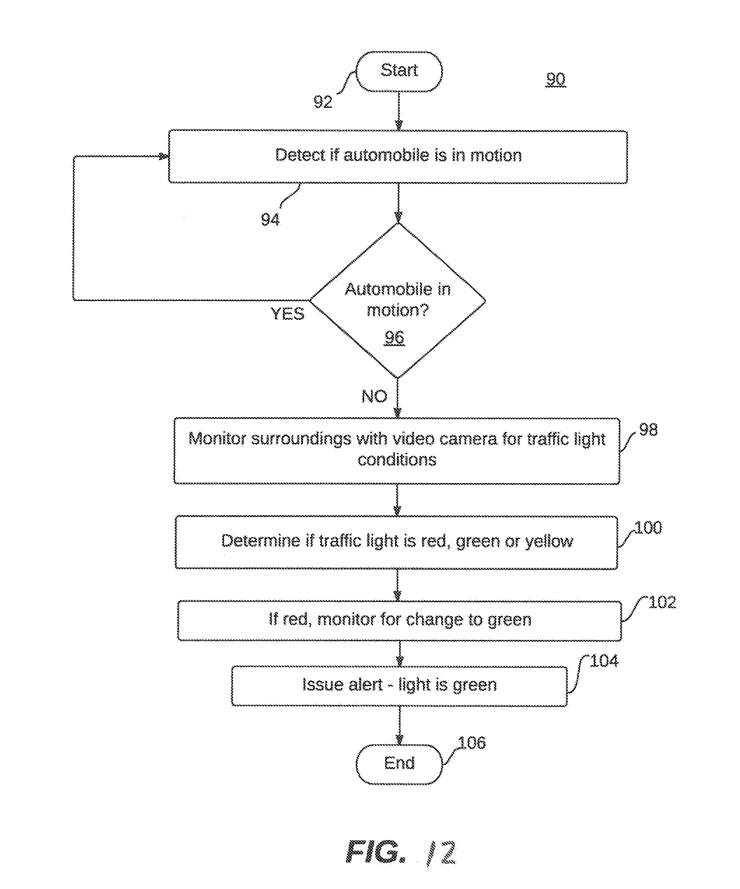

The signal containing data indicative of the alert can be wirelessly transmitted to the computing device 84 (assuming the computing device 84 in this case is, for example, a Bluetooth enabled smartphone or tablet computing device). In some example embodiments, the computing device 84 (assuming a Bluetooth enabled device) may be associated with one or more Bluetooth automotive speakers wherein the signal is processed via the computing device 84 as an audio signal that can be played through the Bluetooth automotive speaker. Another example of a computing system that can be implemented as computing device 84 is the data-processing system 200 and the computer software system discussed in greater detail herein with respect to FIG. 11 and FIG. 12.

The wireless network 85 may be implemented as a PAN (Bluetooth or otherwise), and the signal transmitted through the PAN. It should be appreciated that wireless network 85 may be implemented not just via Bluetooth communications, but through one of a number of possible alternative PAN wireless technologies. For example, in one embodiment wireless network 85 may be implemented as a PAN based on induction wireless technology, which uses magnetic induction rather than radio for close-range communications. In radio, both electric and magnetic fields make up the signal, while in induction wireless, only the magnetic field is transmitted. The transmitter in this context is a radiating coil that is more like the primary winding of a transformer than an antenna. A PAN based on an induction wireless approach has about a 3-m range. A typical unit transmits up to 204.8-kbit/s data rates via GMSK modulation on 11.5 MHz. Key benefits of induction wireless technologies are extremely low power consumption, low cost, and the inherent security that accompanies short range.

Another implementation of wireless network 85 can involve the use of infrared wireless communications. Such a PAN technology can be employed for use over short distances. The IrDA infrared (IR) standard appeared during the early 1990s, and can be utilized to implement wireless network 85 as a PAN network. IrDA initially offered a 115.2-kbit/s data rate over a range of up to 1 m. A 4-Mbit/s version was soon developed and has been widely incorporated in laptops and PDAs for printer connections and short-range PANs. A 16-Mbit/s version is available too

The problem with IrDA is not just its very short range, but also its need for a line-of-sight (LOS) connection. Of course, Bluetooth does not need LOS, and it can blast through walls. A more recent IR development is IrGate, which was produced by Infra-Com Technologies. This new IR development uses arrays of high-powered IR LEDs to emit coded baseband IR in all directions. Then, it relies on an array of photodetectors and super-sensitive receivers to pick up the diffused IR within the networking space. Thus, the LOS problem is mitigated, and a data rate of up to 10 Mbits/s is possible.

Still another wireless technology for implementing wireless network 85 in the context of, for example, an in-vehicle PAN is UWB (Ultra Wideband), which transmits data by way of baseband pulses applied directly to the antenna. The narrow pulses (less than 1 ns) create an extremely broad bandwidth signal. The pulses are modulated by pulse position modulation (PPM) or binary phase-shift keying (BPSK). The FCC permits UWB in the 3.1- to 10.6-GHz band. Its primary application to date has been short-range, high-resolution radar and imaging systems that penetrate walls, the ground, and the body. In addition, this new technology is useful for short-range LANs or PANs that require very high data rates (over 100 Mbits/s).

Still another wireless technology for implementing wireless network 85 in the context of, for example, an in-vehicle PAN is ZigBee, which is a simpler, slower lower-power, lower-cost cousin of Bluetooth, ZigBee. ZigBee is supported by a mix of companies that are targeting the consumer and industrial markets. It may be a better fit with games, consumer electronic equipment, and home-automation applications than Bluetooth. Short-range industrial telemetry and remote control are other target applications. It can be appreciated, however, that wireless network 85 can be implemented as a ZigBee PAN.

Previously referred to as RF-Lite, ZigBee is similar to Bluetooth because it uses the 2.4-GHz band with frequency-hopping spread-spectrum with 25 hops spaced every 4 MHz. The basic data rate is 250 kbits/s, but a slower 28-kbit rate is useful for extended range and greater reliability. With a 20-dBm power level, ZigBee can achieve a range of up to 134 meters at 28 kbits/s. It additionally allows for networking of up to 254 nodes.

Note that in some example embodiments, whether that of FIG. 9 or FIG. 10 or other implementations, camera(s) 82 may be implemented as a 360 degree camera which can be employed for use in monitoring not only conditions within the vehicle but external to vehicle. In a preferred embodiment, camera (s) 82 and/or camera 19 discussed earlier can be implemented as an HD (High Definition) 360 degree camera that provides quality video data that can be monitored via, for example, anomaly detection, machine learning and other techniques.

An example of a 360 degree camera that can be adapted for use with one or more embodiments is the Giroptic 360cam by Gripoptic. Such a device includes three 185-degree fish-eye cameras, allowing it to capture 360 degrees of HD video and photos (including time-lapse and HDR). The example Giroptic 360cam captures audio as well as video, and can record 3D sound from three microphones. Media can be saved onto a microSD card, which is then loaded onto a computer via a micro USB port on the unit's base, or via Wi-Fi. It can be appreciated that such a device (or other 360 degree video cameras) can be modified to communicate via other types of wireless communications, such as Bluetooth communications, cellular, and so forth as discussed herein. Note that reference herein to the Giroptic video camera is for illustrative and exemplary purposes only and is not considered a limiting feature of the disclosed embodiments.

FIG. 11 illustrates a schematic diagram of a system 70 for alerting a vehicle driver via wireless communications, in accordance with an alternative example embodiment. In the alternative example embodiment of system 70 shown in FIG. 11, the monitoring module 72 can utilize an AD (Anomaly Detection) mechanism or module as discussed previously and/or ML (Machine Learning) and/or GPS (Global Positioning Satellite) modules.

ML techniques can be employed in the context of, for example, an algorithm that operates by building a model from example inputs and used to make predictions or decisions, rather than following strictly static program instructions. ML can be used to construct a model or rule set to predict a result based on values with respect to a number of features. A series of input patterns can be provided to an algorithm along with a desired output (e.g., the label) and the algorithm then learns how to classify the patterns by outing a desired label. In supervised learning (e.g., Kernal-based support vector machine (SVM) algorithm), a human operator must provide the labels during a teaching phase. Alternatively, unsupervised clustering is a process of assigning labels to the input patterns without the use of the human operator. Such unsupervised methods generally function through a statistical analysis of the input data by determining an Eigen value vector of a covariance matrix.

One non-limiting ML technique that can be adapted for use in accordance with an embodiment is disclosed in U.S. Patent Application Publication No. 20170307735 entitled “Object Detection Using Radar and Machine Learning” which published on Oct. 26, 2017 and is incorporated herein by reference in its entirety. Another non-limiting ML technique that can be adapted in accordance with another embodiment is disclosed in U.S. Pat. No. 8,429,103 entitled “Native Machine Learning Service for User Adaptation on a Mobile Platform,” which issued on Apr. 23, 2013 and is incorporated herein by reference in its entirety. It can be appreciated that such ML approaches are referred to for illustrative purposes only and are not considered limiting features of the disclosed embodiments.

In the context of the example embodiment shown in FIG. 11, ML can be combined with the AD mechanism to recognize patterns in, for example, video data captured by video camera (s) 19, 82, etc. to detect changes in conditions external to the vehicle or within the vehicle. Location data may also be employed to determine the location of the vehicle with respect to conditions being monitored external or within the vehicle. Location data may include, for example, GPS data and/or other location data, such as, beacon data (e.g., “iBeacon” data, etc.). Note that FIG. 11 illustrates the use of a GPS module and GPS data (i.e., see “GPS” in FIG. 11). It can be appreciated that other types of location data may also be employed such as beacon data, which will be discussed in greater detail herein.

For example, in some embodiments the monitoring operation of monitoring module 74 can involve estimating the distance to a particular point or location near the vehicle and providing a notification/alert via the alerting module 75 in the form of an audio alert, text message etc. ML and/or AD modules or mechanisms can be employed to detect changes in conditions with respect to particular geographic locations. For example, the GPS data may be utilized to determine that the vehicle is rapidly approaching particular crosswalk or intersection and an alert issued to let the driver know that he or she is approaching this particular crosswalk or intersection, while the ML and/or AD modules or techniques can be employed to determine if someone is in the middle of the crosswalk/intersection.

Possible alerts or conditions to be monitored and alerted can be, for example, “approaching a red light,” “changing lanes,” “approaching a median,” “15 feet to a median,” “10 feet to a median,” “at median,” etc. Other possible alerts can be, for example, “trajectory of approaching vehicle dangerously close,” “drop in outside temperature,” “drop in outside pressure,” and so on. The camera(s) 19, 82 and so forth and the monitoring module 75 can look for conditions such as medians, red lights, yellow lights etc. to facilitate a determination of how far away these objects are from the vehicle.

FIG. 12 illustrates a high level flow chart of operations depicting logical operational steps of a method 90 for alerting a vehicle occupant of a change in traffic light conditions via wireless communications, in accordance with an alternative embodiment. As indicated at block 92, the process can be initiated. Thereafter, as disclosed at block 94, a step or logical operation can be implemented for detecting if the occupant's vehicle/automobile is in motion. Thereafter, as shown at decision block 96, a test can be performed to determine if the automobile is in motion. If so, then the monitoring process continues, as shown at block 94. If not, then as indicated at block 98, a video camera (e.g., cameras 19, 21, etc.) can monitor the vehicle's surroundings for traffic light conditions. For example, a step or operation can be implemented to search for and identify a traffic light and its conditions (e.g., red, green or yellow lights).

Note that a non-limiting example of a camera that can be adapted for use in accordance with the operation shown as block 98 and in some implementations for us as the camera 19 discussed earlier herein is a color recognition camera. A non-limiting example of a color recognition camera is disclosed in U.S. Pat. No. 6,803,956 entitled “Color Recognition Camera,” which issued on Oct. 12, 2004 and is incorporated herein by reference in its entirety. Such an example color recognition camera includes a red-green-blue CCD-imaging device that provides an analog RGB-video signal. A set of three analog-to-digital converters converts the analog RGB-video signal into a digital RGB-video signal. A digital comparator tests the digital RGB-video signal pixel-by-pixel for a match against a color setpoint. If a match occurs, a pixel with a particular color represented by the color setpoint has been recognized and a “hit” is output. A pixel address counter provides a pixel address output each time a “hit” is registered. The number of hits per video frame are accumulated, and a color-match area magnitude value is output for each frame. Alternatively, neural networks can be used to indicate hits when a pixel in the video image comes close enough to the color setpoint value. Just how close can be “learned” by the neural network.

As indicated next at block 100, a step or logical operation can be implemented to determine if the light is red, green or yellow. If it is determined, as shown at block 102, that the light is red, then the traffic light is monitored to determine if there is change from to green. Assuming that the light changes from red to green, an alert (e.g., audio) is then issued indicating the change from red to green, as depicted at block 104. The process can then terminate, as shown at block 106.

Note that another color recognition approach that can be adapted for use in accordance with an alternative embodiment and for monitoring a change in color (e.g., traffic light change from yellow to green, red to green, etc.) is disclosed in U.S. Pat. No. 8,139,852 entitled “Color classification method, color recognition method, color classification apparatus, color recognition apparatus, color recognition system, computer program, and recording medium,” which issued on Mar. 12, 2012 and is incorporated herein by reference in its entirety.

Note that in some example embodiments, computer program code for carrying out operations of the disclosed embodiments may be written in an object oriented programming language (e.g., Java, C#, C++, etc.). Such computer program code, however, for carrying out operations of particular embodiments can also be written in conventional procedural programming languages, such as the “C” programming language or in a visually oriented programming environment, such as, for example, Visual Basic.

The program code may execute entirely on the user's computer, partly on the user's computer, as a stand-alone software package, partly on the user's computer and partly on a remote computer or entirely on the remote computer. In the latter scenario, the remote computer may be connected to a user's computer through a local area network (LAN) or a wide area network (WAN), wireless data network e.g., Wi-Fi, Wimax, 802.xx, and cellular network or the connection may be made to an external computer via most third party supported networks (e.g., through the Internet via an Internet Service Provider).

The embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of a general-purpose computer, a special purpose computer, or another programmable data processing apparatus to produce a machine, such that the instructions, which execute via the processor of the computer or other programmable data processing apparatus, create means for implementing the functions/acts specified in the block or blocks. In some example embodiments, a connected car or a self-driving car may themselves be considered a special purpose computer.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the various block or blocks, flowcharts, and other architecture illustrated and described herein.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

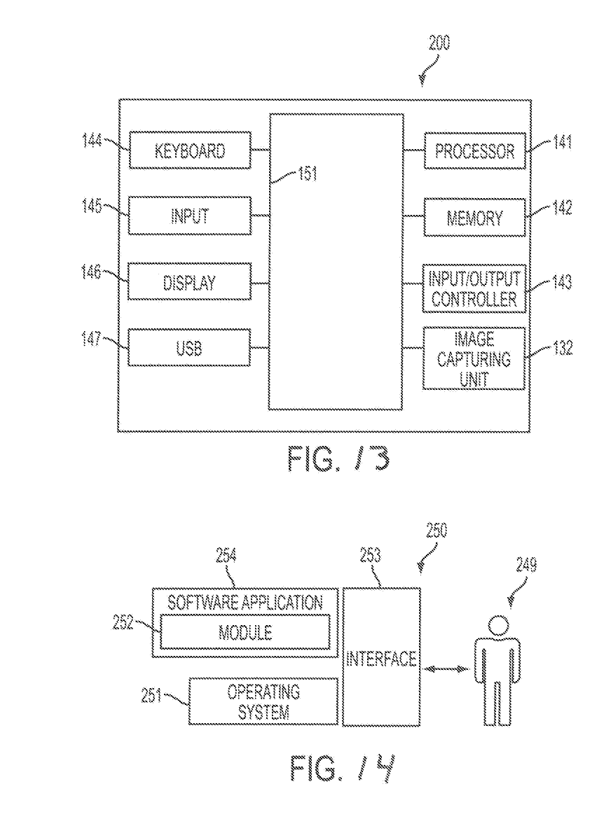

FIGS. 13-14 are shown only as exemplary diagrams of data-processing environments in which embodiments may be implemented. It should be appreciated that FIGS. 13-14 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 13, some example embodiments may be implemented in the context of a data-processing system 200 that can include, for example, one or more processors such as processor 141, a memory 142, a controller 143, a peripheral USB (Universal Serial Bus) connection 147, a display 146, an input device (e.g., a mouse, touch screen display, etc.), a keyboard, etc. Data-processing system 200 may be, for example, a client computing device (e.g., a client PC, laptop, tablet computing device, smartphone, etc.) which can communicate with, for example, a server (not shown) and/or other devices (e.g., wireless and/or wired communications). Note that the display 146 may be a passenger compartment display such as discussed previously herein with respect to FIG. 2, or may be implemented as a display such as a computer monitor, a smartphone display, a tablet computer display, a laptop computer display and so on. The processor may be a processor such as the processor 141 shown in FIG. 2 or vice versa.

As illustrated, the various components of data-processing system 200 can communicate electronically through a system bus 151 or similar architecture. The system bus 151 may be, for example, a subsystem that transfers data between, for example, computer components within data-processing system 200 or to and from other data-processing devices, components, computers, etc. Data-processing system 200 may be implemented as, for example, a server in a client-server based network (e.g., the Internet) or can be implemented in the context of a client and a server (i.e., where aspects are practiced on the client and the server). Data-processing system 200 may also be, for example, a standalone desktop computer, a computer server, a laptop computer, a Smartphone, a pad computing device and so on. In the case of a smartphone, it can be assumed that devices such as keyboard 144, input unit 145 and so on would implemented in the context of a touch screen display or other appropriate mobile input interface. The data-processing system 200 can also include or communicate with an image capturing unit 132 (e.g., a video camera such as discussed herein, etc.).

FIG. 14 illustrates a computer software system 250 for directing the operation of the data-processing system 200. The software application 254 shown in FIG. 14 can be stored in a computer memory such as the memory 202 depicted in FIG. 13. The computer software system 250 generally can include a kernel or operating system 251 and a shell or interface 253. One or more application programs, such as software application 254, may be “loaded” (i.e., transferred from, for example, mass storage 207 or other memory location into the memory 201) for execution by the data-processing system 200. The data-processing system 200 can receive user commands and data through the interface 253; these inputs may then be acted upon by the data-processing system 200 in accordance with instructions from operating system 251 and/or software application 254. The interface 253 in some example embodiments can serve to display results, whereupon a user 249 may supply additional inputs or terminate a session. The software application 254 can include one or more modules such as module 252, which can, for example, implement instructions or operations such as those described herein.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” constitutes a software application.

Generally, program modules include, but are not limited to, routines, subroutines, software applications, programs, objects, components, data structures, etc., that perform particular tasks or implement particular data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular data type. Modules may be composed of two parts: an interface, which lists the constants, data types, variable, and routines that can be accessed by other modules or routines; and an implementation, which is typically private (accessible only to that module) and which includes source code that actually implements the routines in the module. The term module may also simply refer to an application, such as a computer program designed to assist in the performance of a specific task, such as word processing, accounting, inventory management, etc. The module 252 can implemented as, for example, a single module or a group of modules such as modules 74, 75, 76, 78, and 80.

FIGS. 13-14 are thus intended as examples and not as architectural limitations of disclosed embodiments. Additionally, such embodiments are not limited to any particular application or computing or data processing environment. Instead, those skilled in the art will appreciate that the disclosed approach may be advantageously applied to a variety of systems and application software. Moreover, the disclosed embodiments can be embodied on a variety of different computing platforms, including, for example, Windows, Macintosh, UNIX, LINUX, and the like.

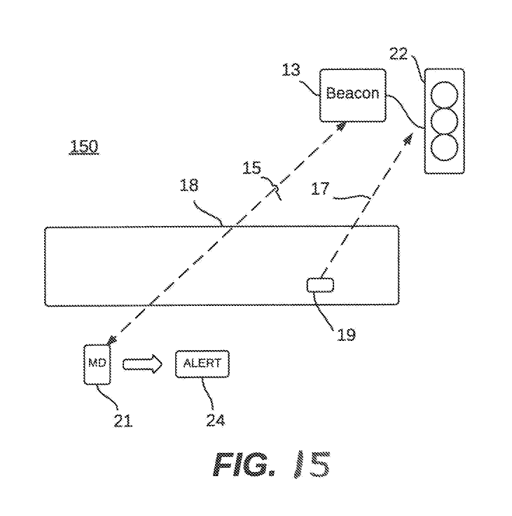

FIG. 15 illustrates a schematic diagram of driver alerting system 150, in accordance with an alternative embodiment. Note that the system 150 shown in FIG. 15 is similar to, for example, system 10 shown in FIG. 3. In the FIG. 15 implementation, however, a beacon 13 is shown as associated with traffic light 22 and can be accessible by nearby mobile electronic devices such as mobile device 21. The beacon 13 is implemented as part of a positioning system. One example of beacon 13 is the “iBeacon” device and associated system. The iBeacon is a trademark of Apple Inc. for a positioning system that Apple Inc. has referred to as a new class of low-powered, low-cost transmitters that can notify nearby iOS devices of their presence. The technology enables a smartphone or other device to perform actions when in close proximity to an iBeacon or in this case beacon 13.

Thus, beacon 13 can assist the mobile computing device 21 in determining its approximate location or context. With the assistance of beacon 13, software associated with mobile computing device 21 can approximately find its relative location with respect to beacon 13 and hence with respect to the traffic light 22 (assuming the beacon 13 is located at or proximate to the traffic light 22). The beacon 13 can communicate with device 21 using BLE (Bluetooth Low Energy) technology also referred to as “Bluetooth Smart”. The beacon 13 uses low energy proximity sensing to transmit a universally unique identifier picked up be a compatible “app” or operating system. The identifier can then be looked up over the Internet to determine the physical location of device 21 or trigger an action on device 21 such as a push notification or tracking and recording operations as discussed previously herein. One non-limiting example of a beacon device and systems that can be adapted for use as or with device 21 and beacon 13 and the methods/systems disclosed herein is discussed in U.S. Pat. No. 8,718,620 entitled “Personal Media Devices with Wireless Communication,” which issued on May 6, 2014 and is incorporated herein by reference.

Note that the term “driver” as utilized herein may refer to the human driver of a vehicle or can refer an autonomous vehicle driver—meaning the autonomous vehicle driving system itself. An example of such an autonomous vehicle driving system is system 500 shown in FIG. 2. Thus, the various alerts discussed herein can be provided to the an AI (Artificial Intelligence) system that governs an autonomously driven vehicle (e.g., a self driving automobile) and/or the actions of the autonomously driven vehicle. The term “vehicle” as utilized herein may refer to a connected vehicle (e.g., a connected car), which may be a human-driven vehicle (i.e., driven by a human driver) or an autonomous vehicle (i.e., also known as a driverless car, a self-driving car, a robotic car, self-driving vehicle, etc). Such an autonomous vehicle or autonomous car is a vehicle that is can sense its environment and navigate without human input. Thus, the term “vehicle” as utilized herein can refer to human driven vehicles (e.g., vehicles driven by a human driver) or an autonomous vehicle.

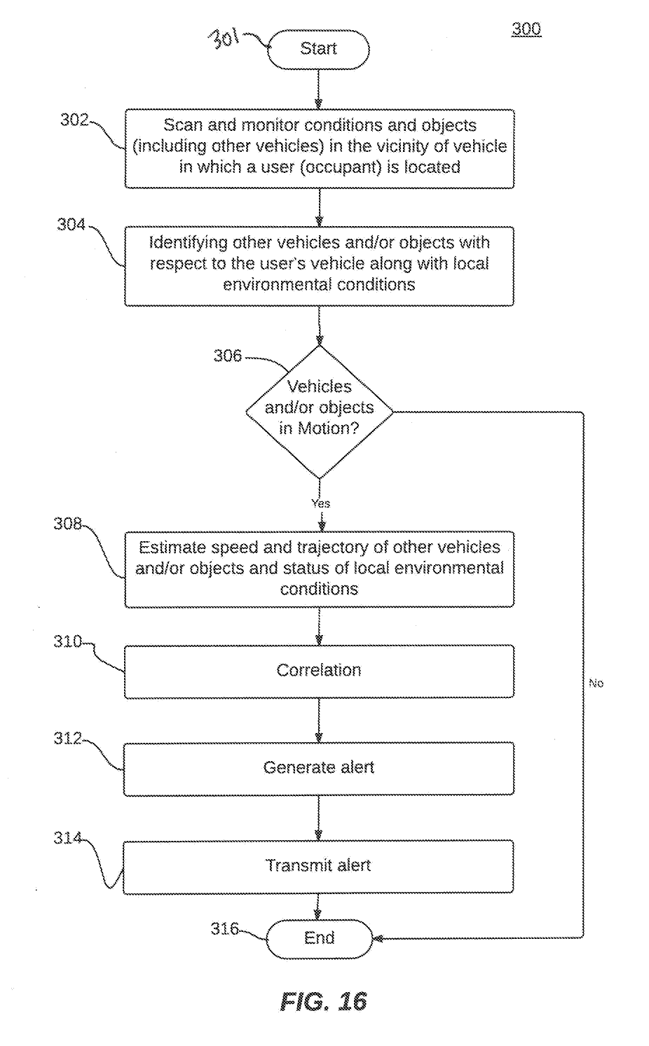

In the case of an autonomous car, a “driver” can refer to a non-human driver such as an AI-enabled autonomous driver (i.e., the AI system that governs or operates the self-driving vehicle). For example, the data-processing system 200 can in some example embodiments be implemented as an AI data-processing system that governs an autonomous vehicle. In other example embodiments, the data-processing system may be the computer system for a connected vehicle (e.g., a connected car), which may or may not be a human-driven vehicle driven by a human driver rather than an AI driver. In some example embodiments, the vehicle may be a combination of a human driven vehicle and an AI driven vehicle. That is, some vehicles may include both a “human driver mode” and an “AI driver mode”. FIG. 16 illustrates a flow chart of operations depicting logical operational steps of a method 300 for gauging vehicle and/or object movement for use in facilitating automotive safety, in accordance with an example embodiment.

Note that as utilized herein, the term “gauging” means measuring, estimating and/or determining the dimensions, capacity, proportions, or amount of something, such as, for example, measuring, estimating and/or determining a particular trajectory of a moving vehicle or object, and/or other factors or parameters such as the velocity, acceleration, angular velocity, angular acceleration, distance from or to, and so on, of a moving vehicle or other object. Gauging thus involves utilizing data acquired from one or more sensors to measure, estimate and/or determining some particular factor such as location, velocity, acceleration, trajectory and so on, of a vehicle or object which may or may not be in motion.

As depicted at block 301, the process begins. Thereafter, as indicated at block 302, a step or operation can be implemented for scanning and monitoring conditions and/or objects (including other vehicles) in the vicinity of a vehicle in which a user (e.g., a vehicle occupant) is located. For example, an occupant may be located in vehicle 105 of FIG. 1. According to the step or operation shown at block 301, one or more of the sensors such as sensors 401, 403, 405, 407, and/or 411 (see FIG. 1) or a group of sensors 400 may scan and monitor conditions and objects such as other vehicles or pedestrians in the vicinity of vehicle 105. The sensors 400 may be implemented in the context of a single type of sensors or in the context of a group of varying sensors of different types.

As indicated next at block 304, a step or operation can be implemented for identifying other vehicles and/or objects with respect to the vehicle 105 in which the user or occupant of the vehicle is located, along with identifying current local environmental conditions, such as the temperature, pressure and/or the current weather (i.e., if it is currently raining, snowing, and/or windy). Note that the identifying operation depicted at block 304 can involve the use of one or more sensors such as a video camera and the use of a feature extraction technique to extract particular features from video captured by such a video camera (or a group of video cameras).

The identifying step shown at block 304 can also involve identifying the types (e.g., car, truck, semi-truck, etc) of the identified objects (e.g., vehicles, pedestrians, etc). The identifying step depicted at block 304 can additionally include the specific identification of the make and the model of the other vehicle or vehicles, for example, and an indication of whether such vehicles comprise autonomous vehicles or vehicles operated by a driver.

Next, as indicated at decision block 306, a test can be implemented to determine if the other identified vehicles (and/or objects) are in motion with respect to the vehicle 105, in response to implementation of the identifying step/operation depicted at block 304. Determining if a vehicle or other objects are in motion can involve detecting the velocity, acceleration and/or trajectory (and/or other factors such as angular acceleration, angular velocity, geolocation of the other other vehicle or object, and so on) of these other identified vehicles or objects. In some example embodiments, sensors such as the previously discussed RADAR and/or LIDAR sensors can be employed to detect such dynamic (moving) objects and whether such objects are moving. Motion can be detected through various sensing means such as, for example, infrared (e.g., passive and active sensors) sensing devices, optics (e.g., video and camera systems), radio frequency energy (e.g., radar, microwave and tomographic motion detection), sound (e.g., microphones and acoustic sensors), vibration (e.g., triboelectric, seismic, and inertia-switch sensors), magnetism (e.g., magnetic sensors and magnetometers).

In some example embodiments, the aforementioned operation for detecting dynamic objects such as vehicles in motion can involve the use of techniques for detecting dynamic objects using sensor signals with 3D information, such as disclosed in non-limiting U.S. Patent Application Publication No. 20100183192, entitled “System and Method for Object Motion Detection Based on Multiple 3D Warping and Vehicle Equipped with Such System,” which published on Jul. 22, 2010 and is incorporated herein by reference in its entirety. Another non-limiting example of a method and related systems and devices for detecting dynamic objects such as vehicles is disclosed in U.S. Patent Application Publication No. US20080273752A1 entitled “System and method for vehicle detection and tracking,” which published on Nov. 6, 2008 and is incorporated herein by reference in its entirety.

If it is determined such identified other vehicles and/or objects are not in motion, then the process terminates, as indicated at block 316. If it is determined, however, that one or more of such identified vehicles and/or objects are in motion, then as indicated at block 308, a test or operation can be implemented to estimate the speed and/or trajectory of these other identified vehicles and/or other objects along with data indicative of the surrounding environmental conditions (e.g., raining, snowing, wet roads, etc). The operation depicted at block 308 can additionally involve in some embodiments, the use of data generated by a GPS sensor that includes a geolocation of vehicle 105 and an estimated geolocation of the other identified vehicles or objects based on the geolocation of vehicle 105. Additionally, the data indicative of the speed and the trajectory of the other vehicle(s) and/or object(s) can include angular data of the other vehicles with respect to vehicle 105 and estimated distances of these other vehicle or vehicles or other objects (e.g., pedestrians) with respect to the vehicle 105 over a time period.

Thereafter, as shown at block 310 an operation can be implemented for correlating the speed and the trajectory the other identified vehicles with the estimated environmental conditions and the type of identified vehicle(s) to generate data indicative of the speed and the trajectory of such vehicle(s), which takes into account the environmental condition(s) and the type of identified vehicle(s). An alert can be then generated, as depicted at block 312, which his indicative of the speed and the trajectory of the other vehicles with respect to vehicle 105 (the vehicle in which the occupant or user is located). Thereafter, as indicated at block 314, a step or operation can be implemented to transmit the alert to the occupant's computing device (e.g., smartphone, wearable computing device, tablet computing device, etc) as an announcement or notification or voice alert such as, for example, “BMW Sedan is Approaching Your Vehicle”. Color may also be factor. For example, the voice alert may be, for example, “Black BMW Sedan is Approaching Your Vehicle” or “Blue BMW SUV is Approaching Your Vehicle”.

The step or operation shown at block 314 can involve transforming the alert into an audio alert or notification and broadcasting the alert through at least one speaker (e.g., speaker or speakers 510) of the vehicle 105. Such an audio alert can include a safety notification regarding a potential safety issue involving the other identified vehicle(s) with respect to vehicle 105 and an identification of the vehicle. Transmission may of the alert to, for example, a client device associated with the user/occupant may occur through a bidirectional packet-based based wireless network such as, for example, the wireless network 85. The process can then end as shown at block 316.

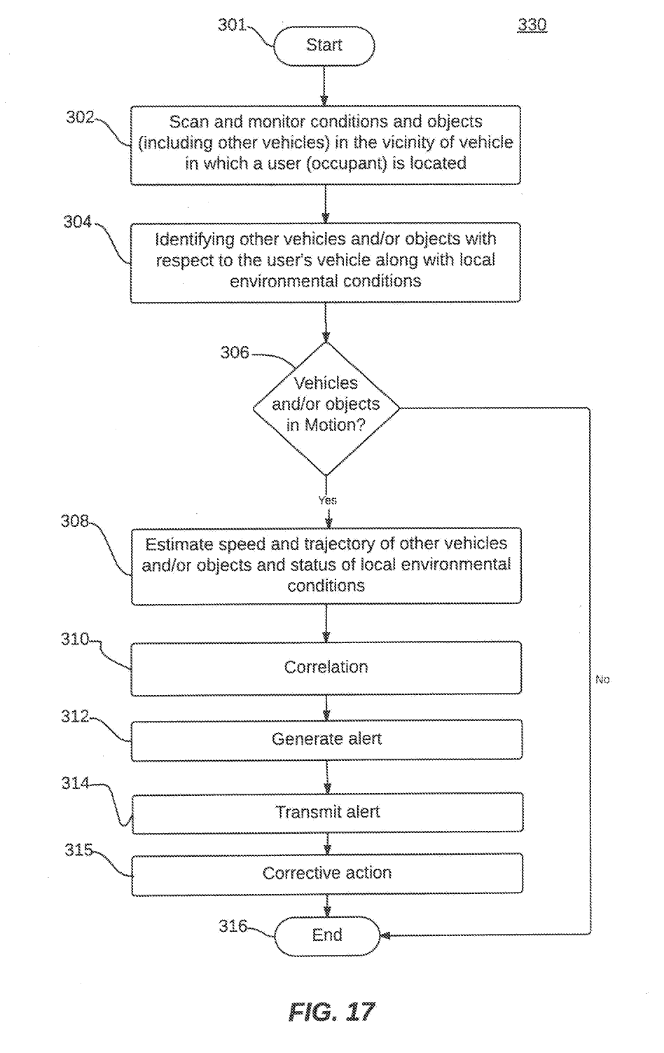

FIG. 17 illustrates a flow chart of operations depicting logical operational steps of a method 330 for gauging vehicle and/or object movement for use in facilitating automotive safety and taking corrective action, in accordance with an example embodiment. Note that similar parts or operations shown in FIGS. 16-17 are indicated by identical reference numerals. The method 330 of FIG. 17 is thus similar to the method 300 shown in FIG. 16. The method 330, however, includes an additional operation. That is, as indicated at block 315, an additional step or operation can be implemented to take corrective action. That is, once the data and alerts concerning the other vehicles and/or objects have been generated, such data can be employed to automatically move the vehicle 105 to a position or location that avoids the trajectory of the identified vehicle(s) or objects to avoid impact with such identified vehicles. This ability to automatically take corrective action for safety purposes is particularly useful in cases where the vehicle driver becomes nervous or agitated during harsh traffic and weather conditions, or in the case of autonomous or semi-autonomous vehicles. That is, the vehicle 105 can be automatically steered away from from an impending impact with another vehicle, if it appears that the other vehicle has a speed and/or trajectory that is estimated to result in an impact with the vehicle 105. This features is also useful for avoiding operational hazards (see previous discussion regarding what constitutes an operational hazard).

Note that the flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. In some alternative example implementations, the function or functions noted in the block may occur out of the order noted in the figures. For example, in some cases, two blocks shown in succession may be executed substantially concurrently, or the blocks may sometimes be executed in the reverse order, depending upon the functionality involved.

The example embodiments can take the form of an entirely hardware embodiment, an entirely software embodiment, or an embodiment containing both hardware and software elements. In a preferred example embodiment, the invention can be implemented with software, which includes but is not limited to firmware, resident software, microcode, etc.

Furthermore, some aspects of the disclosed embodiments can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device). Examples of a computer-readable medium include a semiconductor or solid state memory, magnetic tape, a removable computer diskette, a random access memory (RAM), a read-only memory (ROM), a rigid magnetic disk, a Flash drive, an optical disk, etc. Examples of optical disks include compact disk-read only memory (CD-ROM), compact disk-read/write (CD-R/W), DVD, etc.

Some example embodiments may be implemented in the context of a so-called “app” or software application. An “app” is a self-contained program or piece of software designed to fulfill a particular purpose; an application, especially as downloaded by a user to a mobile device (e.g., smartphone, tablet computing device, etc.).

Based on the foregoing, it can be appreciated that a number of preferred and alternative embodiments are disclosed herein. For example, in one embodiment, a method can be implemented for gauging vehicle movement for use in facilitating automotive safety. Such a method constitutes a non-abstract, technological improvement over known proposals. Such a method can include steps or operations such as determining if at least one object (e.g., another vehicle, truck, car, bicycle, motorcycle, a pedestrian, etc) is in motion with respect to a vehicle in which a user of a vehicle is located, in response to identifying the at least one object with respect to the vehicle in which the user of the vehicle is located, wherein the identifying the at least one object includes identifying a type of the at least one object; estimating a speed and a trajectory of the at least one object and an environmental condition surrounding the at least one object, if it is determined that the at least one object is in motion; correlating the speed and the trajectory of the at least one object with the environmental condition and the type of vehicle to generate data indicative of the speed and the trajectory of the at least one object with respect to the vehicle, which takes into account the environmental condition and the type of the at least one object; and generating an alert indicative of the speed and the trajectory of the at least one object with respect to the vehicle in which the user of the vehicle is located, wherein the alert is based on the data generated.

In some example embodiments, the aforementioned identifying operation can further involve identifying the at least one object with at least one sensor mounted on the vehicle. In some example embodiments, the at least one sensor can include at least one video camera and wherein the at least one object is identified in video captured by the at least one camera by feature extraction of objects contained in the video.

In yet another example embodiment, the at least one sensor includes at least one LIDAR (Light Detection and Ranging) sensor that collects data indicative of a relative location, a size and a shape of objects within a vicinity of the vehicle and the at least one sensor further includes at least one RADAR sensor that provides data indicative of a distance of the at least one object with respect to the vehicle and the data generated includes data derived from the at least one RADAR sensor and the LIDAR sensor. In some example embodiments, a step or operation can be provided for determining if at least one object among the objects within the vicinity of the vehicle comprises the at least one object.

In still another example embodiment, the at least one sensor can include a GPS sensor and the data generated can include a geolocation of the vehicle and an estimation of a geolocation of the at least one object with respect to the vehicle, based on the geolocation of the vehicle. In another example embodiment, the aforementioned identifying step or operation can also involve identifying the make and the model of the at least one object and an indication of whether the at least one object comprises an autonomous vehicle or a vehicle operated by a driver.

In another example embodiment, a step or operation can be implemented for utilizing the data generated to automatically move the vehicle into a position that avoids the trajectory of the at least one object to facilitate automotive safety for the vehicle. In addition, as indicated previously, the data indicative of the speed and the trajectory of the at least one object with respect to the vehicle further includes angular data of an angle (or angles) of the at least one object with respect to the vehicle and the estimated distances of the at least one object to the vehicle over a time period.

In yet another example embodiment, steps or operations are provided for transforming the alert into an audio alert, and broadcasting the audio alert through at least one speaker within the vehicle, wherein aid audio alert includes a safety notification regarding a potential safety issue involving the at least one object with respect to the vehicle and an identification of the least one vehicle.

In still another example embodiment, steps or operations can be provided for transmitting the alert to at least one client device through a bidirectional packet-based based wireless network. In another example embodiment, a step or operation can be provided for monitoring and regulating with a gateway component a rate of data exchanged between the at least one client device and the bidirecitonal packet-based wireless network to allow for optimum data processing for the at least one client device, wherein the gateway component is configured to communicate with the bidirectional packet-based wireless network.

In another example embodiment, a system for gauging vehicle movement for use in facilitating automotive safety, can be implemented. Such a system constitutes a non-abstract, technological improvement over known proposals. The system can include, for example, at least one processor, and a non-transitory computer-usable medium embodying computer program code. The computer-usable medium is capable of communicating with the at least one processor, and the computer program code comprising instructions executable by the at least one processor and configured for: determining if at least one object is in motion with respect to a vehicle in which a user of a vehicle is located, in response to identifying the at least one object with respect to the vehicle in which the user of the vehicle is located, wherein the identifying the at least one object includes identifying a type of the at least one object; estimating a speed and a trajectory of the at least one object and an environmental condition surrounding the at least one object, if it is determined that the at least one object is in motion; correlating the speed and the trajectory of the at least one object with the environmental condition and the type of vehicle to generate data indicative of the speed and the trajectory of the at least one object with respect to the vehicle, which takes into account the environmental condition and the type of the at least one object; and generating an alert indicative of the speed and the trajectory of the at least one object with respect to the vehicle in which the user of the vehicle is located, wherein the alert is based on the data generated.

In another example embodiment, method may be implemented for gauging vehicle movement for use in facilitating automotive safety. Such a method constitutes a non-abstract, technological improvement over known proposals. This method may include, steps, operations or instructions such as, for example, determining if at least one object is in motion with respect to a vehicle in which a user of a vehicle is located, in response to identifying the at least one object with respect to the vehicle in which the user of the vehicle is located with at least one sensor mounted on the vehicle, wherein the identifying the at least one object includes identifying a type of the at least one object, and wherein the at least one sensor includes at least one video camera and wherein the at least one object is identified in video captured by the at least one camera by feature extraction of objects contained in the video, and wherein the at least one sensor further includes at least one LIDAR (Light Detection and Ranging) sensor that collects data indicative of a relative location, a size and a shape of objects within a vicinity of the vehicle and wherein the at least one sensor further includes at least one RADAR sensor that provides data indicative of a distance of the at least one object with respect to the vehicle and the data generated includes data derived from the at least one RADAR sensor and the LIDAR sensor; estimating a speed and a trajectory of the at least one object and an environmental condition surrounding the at least one object, if it is determined that the at least one object is in motion, wherein the data indicative of the speed and the trajectory of the at least one object with respect to the vehicle further includes angular data of an angle of the at least one object with respect to the vehicle and estimated distances of the at least one object to the vehicle over a time period; correlating the speed and the trajectory of the at least one object with the environmental condition and the type of vehicle to generate data indicative of the speed and the trajectory of the at least one object with respect to the vehicle, which takes into account the environmental condition and the type of the at least one object; determining if at least one object among the objects within the vicinity of the vehicle comprises the at least one object, wherein the at least one sensor further includes a GPS sensor and wherein the data generated includes a geolocation of the vehicle and an estimation of a geolocation of the at least one object with respect to the vehicle, based on the geolocation of the vehicle; generating an alert indicative of the speed and the trajectory of the at least one object with respect to the vehicle in which the user of the vehicle is located, wherein the alert is based on the data generated; and utilizing the data generated to automatically move the vehicle into a position that avoids the trajectory of the at least one object to facilitate automotive safety of the vehicle with respect to the at least one object.

In yet another example embodiment, a system for gauging vehicle movement for use in facilitating automotive safety, can be implemented that includes one or more processors, and a non-transitory computer-usable medium embodying computer program code. Such a system constitutes a non-abstract, technological improvement over known proposals. Note that in some embodiments, such a system can be implemented in the context of a vehicle such as described herein. That is, in some example embodiments, the aforementioned system actually be a vehicle such as an autonomous vehicle or a “connected” vehicle as discussed herein.

The aforementioned computer-usable medium is capable of communicating with the aforementioned one or more processors. The computer program code can be configured to include instructions executable by the aforementioned one or more processors and configured for: determining if at least one object is in motion with respect to a vehicle in which a user of a vehicle is located, in response to identifying the at least one object with respect to the vehicle in which the user of the vehicle is located with at least one sensor mounted on the vehicle, wherein the identifying the at least one object includes identifying a type of the at least one object, and wherein the at least one sensor includes at least one video camera and wherein the at least one object is identified in video captured by the at least one camera by feature extraction of objects contained in the video, and wherein the at least one sensor further includes at least one LIDAR (Light Detection and Ranging) sensor that collects data indicative of a relative location, a size and a shape of objects within a vicinity of the vehicle and wherein the at least one sensor further includes at least one RADAR sensor that provides data indicative of a distance of the at least one object with respect to the vehicle and the data generated includes data derived from the at least one RADAR sensor and the LIDAR sensor; estimating a speed and a trajectory of the at least one object and an environmental condition surrounding the at least one object, if it is determined that the at least one object is in motion, wherein the data indicative of the speed and the trajectory of the at least one object with respect to the vehicle further includes angular data of an angle of the at least one object with respect to the vehicle and estimated distances of the at least one object to the vehicle over a time period; correlating the speed and the trajectory of the at least one object with the environmental condition and the type of vehicle to generate data indicative of the speed and the trajectory of the at least one object with respect to the vehicle, which takes into account the environmental condition and the type of the at least one object; determining if at least one object among the objects within the vicinity of the vehicle comprises the at least one object, wherein the at least one sensor further includes a GPS sensor and wherein the data generated includes a geolocation of the vehicle and an estimation of a geolocation of the at least one object with respect to the vehicle, based on the geolocation of the vehicle; generating an alert indicative of the speed and the trajectory of the at least one object with respect to the vehicle in which the user of the vehicle is located, wherein the alert is based on the data generated; and utilizing the data generated to automatically move the vehicle into a position that avoids the trajectory of the at least one object to facilitate automotive safety of the vehicle with respect to the at least one object.

In still another example embodiment, a system can be implemented for gauging vehicle movement for use in facilitating automotive safety. Such a system constitutes a non-abstract, technological improvement over known proposals. In such an example embodiment, the system can include one or more processors and a non-transitory computer-usable medium embodying computer program code. Such computer-usable medium is capable of communicating with the processor (or processors), and the computer program code can include instructions executable by the processor or processors and configured for: determining if at least one object is in motion with respect to a vehicle in which a user of the vehicle is located, in response to identifying the at least one object with respect to the vehicle in which the user of the vehicle is located with at least one sensor mounted on the vehicle, wherein the identifying the at least one object includes identifying a type of the at least one object, and wherein the at least one sensor includes at least one video camera and wherein the at least one object is identified in video captured by the at least one camera by feature extraction of objects contained in the video, and wherein the at least one sensor further includes at least one LIDAR (Light Detection and Ranging) sensor that collects data indicative of a relative location, a size and a shape of objects within a vicinity of the vehicle and wherein the at least one sensor further includes at least one RADAR sensor that provides data indicative of a distance of the at least one object with respect to the vehicle and the data generated includes data derived from the at least one RADAR sensor and the LIDAR sensor; estimating a speed and a trajectory of the at least one object and an environmental condition surrounding the at least one object, if it is determined that the at least one object is in motion, wherein the data indicative of the speed and the trajectory of the at least one object with respect to the vehicle further includes angular data of an angle of the at least one object with respect to the vehicle and estimated distances of the at least one object to the vehicle over a time period; correlating the speed and the trajectory of the at least one object with the environmental condition and the type of vehicle to generate data indicative of the speed and the trajectory of the at least one object with respect to the vehicle, which takes into account the environmental condition and the type of the at least one object; determining if at least one object among the objects within the vicinity of the vehicle comprises the at least one object, wherein the at least one sensor further includes a GPS sensor and wherein the data generated includes a geolocation of the vehicle and an estimation of a geolocation of the at least one object with respect to the vehicle, based on the geolocation of the vehicle; generating an alert indicative of the speed and the trajectory of the at least one object with respect to the vehicle in which the user of the vehicle is located, wherein the alert is based on the data generated; broadcasting the alert through a speaker associated with the vehicle and/or through a speaker of a client device associated with the user, wherein the client device is in communication with a PAN (Personal Area Network) associated with the vehicle and/or the client device is in communication with a cellular communications network and the alert is transmitted through the PAN and/or the cellular communications network for the broadcasting respectively through the speaker associated with the vehicle and/or the speaker of the client device; and utilizing the data generated to automatically move the vehicle into a position that avoids the trajectory of the at least one object to facilitate automotive safety of the vehicle with respect to the at least one object.

It will be appreciated that various systems, methods, apparatuses, and computer program products are disclosed herein for gauging vehicle movement for use in facilitating automotive safety. While particular embodiments have been shown and described, it will be obvious to those skilled in the art that, based upon the teachings herein, changes and modifications may be made without departing from this invention and its broader aspects. Therefore, the appended claims are to encompass within their scope all such changes and modifications as are within the true spirit and scope of the disclosed embodiments. Furthermore, it is to be understood that the disclosed embodiments are defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim elements to embodiments containing only one such element, even when the same claim includes the introductory phrases “one or more” or “at least one” and indefinite articles such as “a” or “an”; the same holds true for the use in the claims of definite articles.

The disclosed embodiments may be a system, a method, and/or a computer program product. In addition, selected embodiments may take the form of an entirely hardware embodiment, an entirely software embodiment (including firmware, resident software, micro-code, etc.) or an embodiment combining software and/or hardware aspects that may all generally be referred to herein as a “circuit,” “module” or “system.” Furthermore, aspects of the disclosed embodiments may take the form of computer program product embodied in a computer readable storage medium (or media) having computer readable program instructions thereon for causing a processor to carry out aspects of the disclosed embodiments.

A computer readable storage medium can be a tangible device that can retain and store instructions for use by an instruction execution device. A computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the disclosed embodiments.

Aspects of the disclosed embodiments are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Further, it should be understood that all subject matter disclosed herein is directed, and should be read, only on statutory, non-abstract subject matter. All terminology should be read to include only the portions of the definitions which may be claimed. By way of example, “computer readable storage medium” is understood to be defined as only non-transitory storage media.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art, which are also intended to be encompassed by the following claims.

What is claimed is:

1. A method for gauging vehicle movement for use in facilitating automotive safety, the method comprising:
determining if at least one object is in motion with respect to a vehicle in which a user of said vehicle is located, in response to identifying said at least one object with respect to said vehicle in which said user of said vehicle is located, wherein said identifying said at least one object includes identifying a type of said at least one object;
estimating a speed and a trajectory of said at least one object and an environmental condition surrounding said at least one object, if it is determined that said at least one object is in motion;
correlating said speed and said trajectory of said at least one object with said environmental condition and said type of said at least one object to generate data indicative of said speed and said trajectory of said at least one object with respect to said vehicle, which takes into account said environmental condition and said type of said at least one object; and
generating and broadcasting an alert indicative of said speed and said trajectory of said at least one object with respect to said vehicle in which said user of said vehicle is located, wherein said alert is based on said data generated.

2. The method of claim 1 wherein said identifying said at least one object further comprises identifying said at least one object with at least one sensor mounted on said vehicle.

3. The method of claim 2 wherein said at least one sensor includes at least one video camera and wherein said at least one object is identified in video captured by said at least one camera by feature extraction of objects contained in said video.

4. The method of claim 2 wherein said at least one sensor includes at least one LIDAR (Light Detection and Ranging) sensor that collects data indicative of a relative location, a size and a shape of objects within a vicinity of said vehicle and said at least one sensor further includes at least one RADAR sensor that provides data indicative of a distance of said at least one object with respect to said vehicle and said data generated includes data derived from said at least one RADAR sensor and said LIDAR sensor, wherein said at least one sensor further includes a GPS sensor and wherein said data generated includes a geolocation of said vehicle and an estimation of a geolocation of said at least one object with respect to said vehicle, based on said geolocation of said vehicle, and further comprising determining if at least one object among said objects within said vicinity of said vehicle comprises said at least one object.

5. The method of claim 1 wherein said identifying said at least one object further comprises identifying a make and a model of said at least one object and an indication of whether said at least one object comprises an autonomous vehicle or a vehicle operated by a driver.

6. The method of claim 1 further comprising utilizing said data generated to automatically move said vehicle into a position that avoids said trajectory of said at least one object to facilitate automotive safety of said vehicle, and wherein said data indicative of said speed and said trajectory of said at least one object with respect to said vehicle further includes angular data of an angle of said at least one object with respect to said vehicle and estimated distances of said at least one object to said vehicle over a time period.

7. The method of claim 1 further comprising:
transmitting said alert to at least one client device through a bidirectional packet-based based wireless network; and
monitoring and regulating with a gateway component a rate of data exchanged between said at least one client device and said bidirecitonal packet-based wireless network to allow for optimum data processing for said at least one client device, wherein said gateway component is configured to communicate with said bidirectional packet-based wireless network.

8. A system for gauging the vehicle movement for use in facilitating automotive safety, said system comprising:
at least one processor; and
a non-transitory computer-usable medium embodying computer program code, said computer-usable medium capable of communicating with said at least one processor, said computer program code comprising instructions executable by said at least one processor and configured for:
determining if at least one object is in motion with respect to a vehicle in which a user of said vehicle is located, in response to identifying said at least one object with respect to said vehicle in which said user of said vehicle is located, wherein said identifying said at least one object includes identifying a type of said at least one object;
estimating a speed and a trajectory of said at least one object and an environmental condition surrounding said at least one object, if it is determined that said at least one object is in motion;
correlating said speed and said trajectory of said at least one object with said environmental condition and said type of said at least one object to generate data indicative of said speed and said trajectory of said at least one object with respect to said vehicle, which takes into account said environmental condition and said type of said at least one object; and
generating an alert indicative of said speed and said trajectory of said at least one object with respect to said vehicle in which said user of said vehicle is located, wherein said alert is based on said data generated.

9. The system of claim 8 wherein said identifying said at least one object further comprises identifying said at least one object with at least one sensor mounted on said vehicle.

10. The system of claim 9 wherein said at least one sensor includes at least one video camera and wherein said at least one object is identified in video captured by said at least one camera by feature extraction of objects contained in said video.

11. The system of claim 9 wherein said at least one sensor includes at least one LIDAR (Light Detection and Ranging) sensor that collects data indicative of a relative location, a size and a shape of objects within a vicinity of said vehicle and said at least one sensor further includes at least one RADAR sensor that provides data indicative of a distance of said at least one object with respect to said vehicle and said data generated includes data derived from said at least one RADAR sensor and said LIDAR sensor.

12. The system of claim 8 further comprising determining if at least one object among said objects within said vicinity of said vehicle comprises said at least one object.

13. The system of claim 10 wherein said at least one sensor further includes a GPS sensor and wherein said data generated includes a geolocation of said vehicle and an estimation of a geolocation of said at least one object with respect to said vehicle, based on said geolocation of said vehicle.

14. The system of claim 9 wherein said instructions for identifying said at least one object further comprises instructions for identifying a make and a model of said at least one object and an indication of whether said at least one object comprises an autonomous vehicle or a vehicle operated by a driver.

15. The system of claim 9 wherein said instructions are further configured for utilizing said data generated to automatically move said vehicle into a position that avoids said trajectory of said at least one object to facilitate automotive safety of said vehicle.

16. The system of claim 9 wherein said vehicle comprises an autonomous vehicle and said user of said vehicle comprises a passenger of said vehicle.

17. The system of claim 9 wherein said data indicative of said speed and said trajectory of said at least one object with respect to said vehicle further includes angular data of an angle of said at least one object with respect to said vehicle and estimated distances of said at least one object to said vehicle over a time period.

18. The system of claim 9 wherein said instructions are further configured for:
transforming said alert into an audio alert; and
broadcasting said audio alert through at least one speaker within said vehicle, wherein aid audio alert includes a safety notification regarding a potential safety issue involving said at least one object with respect to said vehicle and an identification of said least one vehicle.

19. The system of claim 9 wherein said instructions are further configured for:
transmitting said alert to at least one client device through a bidirectional packet-based based wireless network; and
monitoring and regulating with a gateway component a rate of data exchanged between said at least one client device and said bidirecitonal packet-based wireless network to allow for optimum data processing for said at least one client device, wherein said gateway component is configured to communicate with said bidirectional packet-based wireless network, and wherein said gateway component comprises a gateway that communicates with said bidirectional packet-based based wireless network.

20. A vehicle configured to gauge vehicle movement for use in facilitating automotive safety, said system comprising:
at least one processor; and
a non-transitory computer-usable medium embodying computer program code, said computer-usable medium capable of communicating with said at least one processor, said computer program code comprising instructions executable by said at least one processor and configured for:
determining if at least one object is in motion with respect to a vehicle in which a user of said vehicle is located, in response to identifying said at least one object with respect to said vehicle in which said user of said vehicle is located with at least one sensor mounted on said vehicle, wherein said identifying said at least one object includes identifying a type of said at least one object, and wherein said at least one sensor includes at least one video camera and wherein said at least one object is identified in video captured by said at least one camera by feature extraction of objects contained in said video, and wherein said at least one sensor further includes at least one LIDAR (Light Detection and Ranging) sensor that collects data indicative of a relative location, a size and a shape of objects within a vicinity of said vehicle and wherein said at least one sensor further includes at least one RADAR sensor that provides data indicative of a distance of said at least one object with respect to said vehicle and said data generated includes data derived from said at least one RADAR sensor and said LIDAR sensor,
estimating a speed and a trajectory of said at least one object and an environmental condition surrounding said at least one object, if it is determined that said at least one object is in motion, wherein said data indicative of said speed and said trajectory of said at least one object with respect to said vehicle further includes angular data of an angle of said at least one object with respect to said vehicle and estimated distances of said at least one object to said vehicle over a time period;
correlating said speed and said trajectory of said at least one object with said environmental condition and said type of said at least one object to generate data indicative of said speed and said trajectory of said at least one object with respect to said vehicle, which takes into account said environmental condition and said type of said at least one object;
determining if at least one object among said objects within said vicinity of said vehicle comprises said at least one object, wherein said at least one sensor further includes a GPS sensor and wherein said data generated includes a geolocation of said vehicle and an estimation of a geolocation of said at least one object with respect to said vehicle, based on said geolocation of said vehicle;
generating an alert indicative of said speed and said trajectory of said at least one object with respect to said vehicle in which said user of said vehicle is located, wherein said alert is based on said data generated;
broadcasting said alert through a speaker associated with said vehicle and/or through a speaker of a client device associated with said user, wherein said client device is in communication with a PAN (Personal Area Network) associated with said vehicle and/or the client device is in communication with a cellular communications network and said alert is transmitted through said PAN and/or said cellular communications network for said broadcasting respectively through said speaker associated with said vehicle and/or said speaker of said client device; and
utilizing said data generated to automatically move said vehicle into a position that avoids said trajectory of said at least one object to facilitate automotive safety of said vehicle with respect to said at least one object.
